(19) United States
(12) Patent Application Publication
(10) Pub. No.: US 2026/0231009 A1
(43) Pub. Date: Aug. 6, 2026

(54) USER EQUIPMENT (UE)

(71) Applicant: SHARP KABUSHIKI KAISHA, Sakai City, Osaka (JP)

(72) Inventor: YASUO SUGAWARA, Sakai City, Osaka (JP)

(21) Appl. No.: 19/145,830

(22) PCT Filed: Nov. 14, 2023
(86) PCT No.: PCT/JP2023/040838

§ 371 Date: Jul. 3, 2025

(30) Foreign Application Priority Data
Jan. 6, 2023 (JP) 2023-000826

(51) Int. Cl. H04W 48/18; H04W 48/08

(52) U.S. Cl. CPC H04W 48/18; H04W 48/08

(57) ABSTRACT

Detailed behaviors of a UE and a network are clarified in order to efficiently support temporally restricted NSs. A UE transmits a registration request message including information indicating support for a temporary network slice, receives a registration accept message or a registration reject message including allowed NSSAI or configured NSSAI including S-NSSAI indicating the temporary network slice, and a timer value corresponding to the S-NSSAI, starts a timer using the timer value, stores the S-NSSAI in allowed NSSAI or configured NSSAI in the UE, and, in a case that the timer expires, removes the S-NSSAI from the allowed NSSAI or the configured NSSAI in the UE, and stores the S-NSSAI in rejected NSSAI in the UE.

### TECHNICAL FIELD

The present invention relates to a User Equipment (UE). This application claims priority based on JP 2023-000826 filed on Jan. 6, 2023, the contents of which are incorporated herein by reference.

### Background Art

In the 3rd Generation Partnership Project (3GPP), system architecture related to a fifth generation (5G) mobile communication system (also referred to as a 5G System or a 5GS) has been studied. (See NPL 1 to NPL 3). In 3GPP, at present, as one of studies for specifications of Release 18, discussions related to enhancement of network slice (also referred to as NS) functions have been carried out (see NPL 4).

### CITATION LIST

### Non Patent Literature

NPL 1:3GPP TS 23.501 V 18.0.0(2022 -12); 3rd Generation Partnership Project; Technical Specification Group Services and System Aspects; System architecture for the 5G System (5GS); Stage 2 (Release 18)

NPL 2:3GPP TS 23.502 V 18.0.0(2022 -12); 3rd Generation Partnership Project; Technical Specification Group Services and System Aspects; Procedures for the 5G System (5GS); Stage 2 (Release 17)

NPL 3:3GPP TS 24.501 V 18.0.1(2022 -09); 3rd Generation Partnership Project; Technical Specification Group Core Network and Terminals; Non-Access-Stratum (NAS) protocol for 5G System (5GS); Stage 3 (Release 17)

NPL 4:3GPP TR 23.700-41 V 18.0.0(2022 -12); 3rd Generation Partnership Project; Technical Specification Group Services and System Aspects; Study on enhancement of network slicing; Phase 3 (Release 18)

### SUMMARY OF INVENTION

### Technical Problem

Although NPL 4 studies, as the 5GS, how to support a case that NSs are temporally restricted in Release 18, detailed behaviors of a UE and a network have not yet been clarified.

An aspect of the present invention is made in view of the circumstances as described above, and is to clarify detailed behaviors of a UE and a network in order to efficiently support temporally restricted NSs.

### Solution to Problem

A UE according to an embodiment of the present invention is a User Equipment (UE) including a transmission and/or reception unit, a controller, and a storage unit. The transmission and/or reception unit transmits a registration request message including information indicating support for a temporary network slice and receives a registration accept message or a registration reject message including allowed NSSAI or configured NSSAI and a timer value. The allowed NSSAI and the configured NSSAI include S-NSSAI indicating the temporary network slice, and the timer value corresponds to the S-NSSAI. The controller starts a timer using the timer value, stores the S-NSSAI in allowed NSSAI or configured NSSAI in the storage unit, and, in a case that the timer expires, removes the S-NSSAI from the allowed NSSAI or the configured NSSAI in the storage unit, and stores the S-NSSAI in rejected NSSAI in the storage unit.

### Advantageous Effects of Invention

According to an aspect of the present invention, detailed behaviors of a UE and a network can be clarified in order to efficiently support temporally restricted NSs.

### BRIEF DESCRIPTION OF DRAWINGS

FIG. 1 is a diagram illustrating an overview of a mobile communication system (EPS/5GS).

FIG. 2 is a diagram illustrating a detailed configuration of the mobile communication system (EPS/5GS).

FIG. 3 is a diagram illustrating an apparatus configuration of a UE.

FIG. 4 is a diagram illustrating a configuration of an access network apparatus (gNB) in the 5GS.

FIG. 5 is a diagram illustrating a configuration of a core network apparatus (AMF/SMF/UPF) in the 5GS.

FIG. 6 is a diagram illustrating a registration procedure.

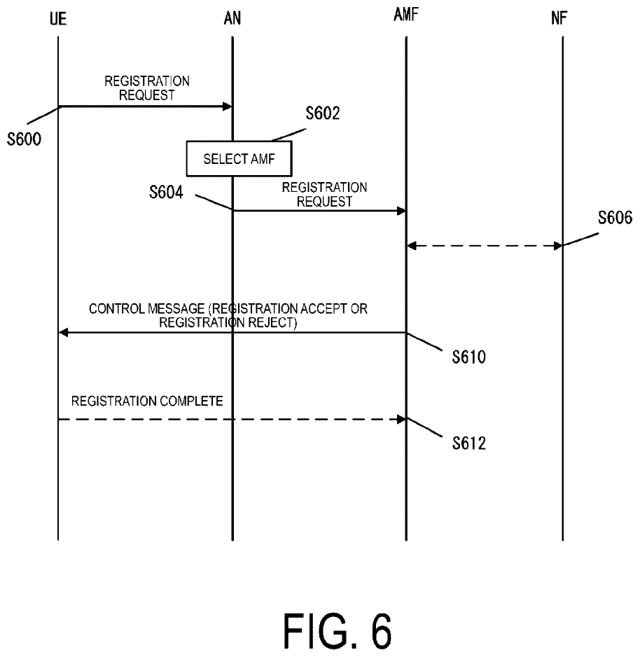

### Description of Embodiments

Preferred embodiments for carrying out the present invention will be described below with reference to the drawings. Note that an embodiment of a mobile communication system to which the present invention is applied will be described as an example in the present embodiment.

### 1. Overview of System

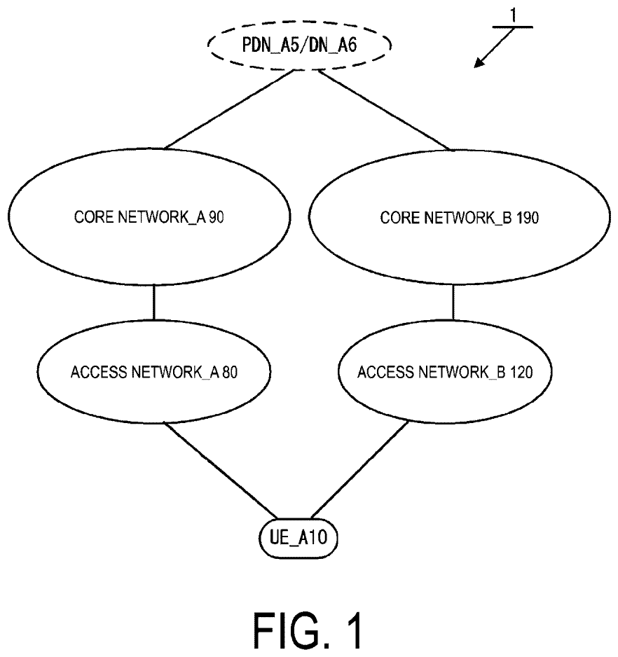

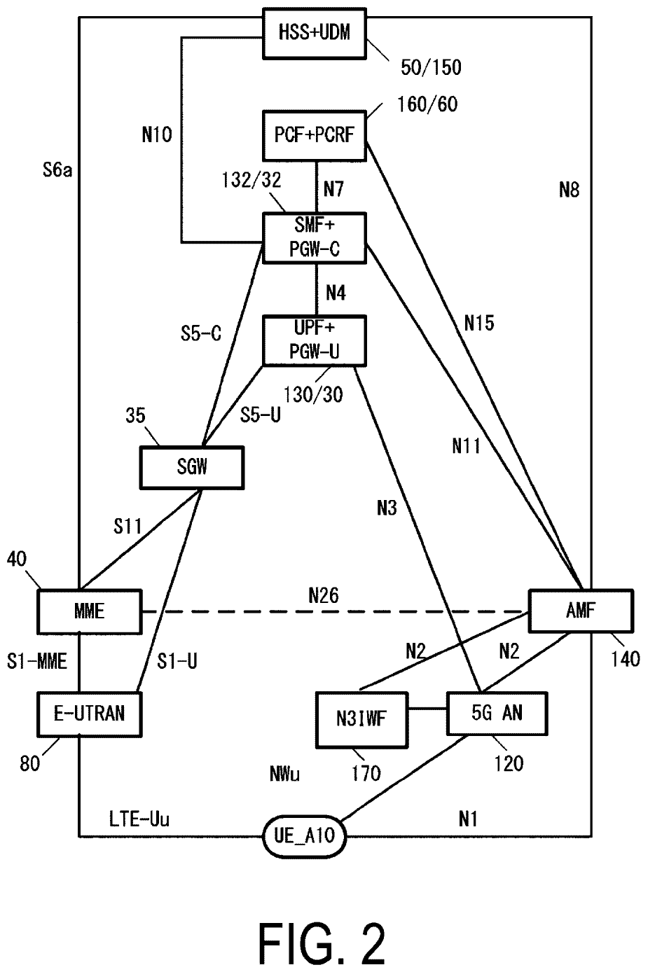

First, FIG. 1 is a diagram illustrating an overview of a mobile communication system 1 used in each embodiment, and FIG. 2 is a diagram illustrating a detailed configuration of the mobile communication system 1.

FIG. 1 illustrates the mobile communication system 1 including a UE_A 10, an access network_A 80, a core network_A 90, a Packet Data Network (PDN)_A 5, an access network_B 120, a core network_B 190, and a Data Network (DN)_A 6.

In the following description, the reference numerals of these apparatuses and functions may be omitted, as in a UE, an access network_A, a core network_A, a PDN, an access network_B, a core network_B, a DN, and the like.

In addition, FIG. 2 illustrates apparatuses and functions such as the UE_A 10, an E-UTRAN 80, an MME 40, an SGW 35, a PGW-U 30, a PGW-C 32, a PCRF 60, an HSS 50, a 5G AN 120, an AMF 140, a UPF 130, an SMF 132, a PCF 160, a UDM 150, and an N3IWF 170, and interfaces for connecting these apparatuses and functions to each other.

In the following description, the reference numerals of these apparatuses and functions may be omitted as in a UE, an E-UTRAN, an MME, an SGW, a PGW-U, a PGW-C, a PCRF, an HSS, a 5G AN, an AMF, a UPF, an SMF, a PCF, a UDM, an N3IWF, and the like.

Note that an Evolved Packet System (EPS) that is a 4G system includes an access network A and a core network_A and may further include a UE and/or a PDN. In addition, a 5G System (5GS) that is a 5G system includes a UE, an access network_B, and a core network B and may further include a DN.

The UE is an apparatus that can be connected to a network service over 3GPP access (also referred to as a 3GPP access network or a 3GPP AN) and/or non-3GPP access (also referred to as a non-3GPP access network or a non-3GPP AN). The UE may be a terminal apparatus capable of performing radio communication, such as a mobile phone or a smartphone, and may be a terminal apparatus that can be connected to both the EPS and the 5GS. The UE may include a Universal Integrated Circuit Card (UICC) and an Embedded UICC (eUICC). Note that the UE may be referred to as user equipment or a terminal apparatus.

In addition, the access network_A corresponds to an Evolved Universal Terrestrial Radio Access Network (E-UTRAN) and/or a wireless LAN access network. In the E-UTRAN, one or more evolved Node Bs (eNBs) 45 are deployed. Note that, in the following description, the reference numeral of the eNB 45 may be omitted as in eNB. In addition, in a case that there are multiple eNBs, the eNBs are connected to each other via, for example, an X2 interface. In addition, one or more access points are deployed on the wireless LAN access network.

In addition, the access network_B corresponds to a 5G access network (5G AN). The 5G AN includes an NG Radio Access Network (NG-RAN) and/or a non-3GPP access network. One or more NR NodeBs (gNBs) 122 are deployed on the NG-RAN. Note that, in the following description, the reference numeral of the gNB 122 may be omitted, as in eNB. The gNB is a node that provides a New Radio (NR) user plane and control plane to the UE, and is connected to a 5GCN via an NG interface (including an N2 interface or an N3 interface). In other words, the gNB is a base station apparatus newly designed for the 5GS and has functions different from those of the base station apparatus (eNB) used in the EPS that is a 4G system. In addition, in a case that there are multiple gNBs, the gNBs are connected to each other via, for example, an Xn interface.

In addition, a non-3GPP access network may be an untrusted non-3GPP access network or a trusted non-3GPP access network. Here, the untrusted non-3GPP access network may be a non-3GPP access network that does not manage security on the access network, for example, a public wireless LAN. On the other hand, the trusted non-3GPP access network may be an access network defined by 3GPP and may include a trusted non-3GPP access point (TNAP) and a trusted non-3GPP Gateway function (TNGF).

The NG-RAN refers to a radio access network connected to the 5GCN, and may use NR and/or E-UTRA. In other words, the NG-RAN may be an E-UTRAN.

In addition, in the following description, the E-UTRAN and the NG-RAN may be referred to as 3GPP access. In addition, the wireless LAN access network and the non-3GPP AN may be referred to as non-3GPP access. In addition, nodes deployed on the access network_B may also be collectively referred to as NG-RAN nodes.

In addition, in the following description, the access network_A, and/or the access network_B, and/or an apparatus included in the access network_A, and/or an apparatus included in the access network B may be referred to as an access network or an access network apparatus.

The core network_A corresponds to an Evolved Packet Core (EPC). In the EPC, for example, a Mobility Management Entity (MME), a Serving Gateway (SGW), a Packet Data Network Gateway (PGW)-U, a PGW-C, a Policy and Charging Rules Function (PCRF), a Home Subscriber Server (HSS), and the like are deployed.

In addition, the core network_B corresponds to a 5G Core Network (5GCN). An Access and Mobility Management Function (AMF), a User Plane Function (UPF), a Session Management Function (SMF), a Policy Control Function (PCF), a Unified Data Management (UDM), and the like are deployed on the 5GCN. Here, the 5GCN may be referred to as a 5GC.

In addition, in the following description, the core network_A, and/or the core network B, an apparatus included in the core network_A, and/or an apparatus included in the core network_B may be referred to as a core network, a core network apparatus, or an intra-core network apparatus.

The core network (the core network_A and/or the core network_B) may refer to an IP mobile communication network operated by a mobile communication operator (Mobile Network Operator (MNO)) connecting the access network (the access network_A and/or the access network_B) and the PDN and/or the DN, a core network for a mobile communication operator that operates and manages the mobile communication system 1, or a core network for a virtual mobile communication operator and a virtual mobile communication service provider such as a Mobile Virtual Network Operator (MVNO) and a Mobile Virtual Network Enabler (MVNE).

The core network (the core network_A and/or the core network_B) and the access network (access network_A and/or the access network_B) may differ for each mobile communication operator.

In addition, although FIG. 1 illustrates a case that the PDN and the DN are the same, the PDN and the DN may be different. The PDN may be a Data Network (DN) that provides communication services to the UE. Note that the DN may be configured as a packet data service network or may be configured for each service. In addition, the PDN may include a connected communication terminal. Thus, “to be connected to the PDN” may mean “to be connected to a communication terminal and/or a server apparatus deployed in the PDN”. In addition, “to transmit and/or receive user data to and/or from the PDN” may mean “to transmit and/or receive user data to and/or from a communication terminal and/or a server apparatus deployed in the PDN”. Note that the PDN may be referred to as a DN, and the DN may be referred to as a PDN.

In addition, in the following, at least some of the access network_A, the core network_A, the PDN, the access network_B, the core network_B, and the DN, and/or one or more apparatuses included in these may be referred to as a network or a network apparatus. In other words, the expression that “the network and/or the network apparatus transmits and/or receives a message and/or performs a procedure” means that “at least some of the access network_A, the core network_A, the PDN, the access network_B, the core network_B, and the DN, and/or one or more apparatuses included in these transmit and/or receive a message and/or perform a procedure”.

In addition, the UE can be connected to the access network. The UE can be connected to the core network over the access network. In addition, the UE can be connected to the PDN or the DN over the access network and the core network. In other words, the UE can transmit and/or receive (communicate) user data to and/or from the PDN or the DN. In a case that user data is transmitted and/or received, not only Internet Protocol (IP) communication but also non-IP communication may be used.

Here, IP communication refers to data communication using the IP, and data is transmitted and/or received using IP packets. Each IP packet includes an IP header and a payload part. In the payload part, data transmitted and/or received by the apparatuses and functions included in the EPS and the apparatuses and functions included in the 5GS may be included. Non-IP communication refers to data communication not using the IP, where data is transmitted and/or received in a form different from the structure of the IP packets. For example, non-IP communication may be data communication implemented through transmission and/or reception of application data to which an IP header is not added, or user data transmitted and/or received by the UE may be transmitted and/or received with another header such as a MAC header and an Ethernet (trade name) frame header added.

In addition, apparatuses which are not illustrated in FIG. 2 may be included in the access network A, the core network_A, the access network_B, the core network_B, the PDN_A, and the DN_A. For example, the core network_A and/or the core network B and/or the PDN A and/or the DN_A may include an Authentication Server Function (AUSF) and an Authentication, authorization, and accounting (AAA) server (AAA-S). The AAA server may be deployed outside the core network.

Here, the AUSF is a core network apparatus provided with an authentication function for 3GPP access and non-3GPP access. Specifically, the AUSF is a network function unit that receives an authentication request for 3GPP access and/or non-3GPP access from the UE and performs an authentication procedure.

The AAA server is an apparatus that is connected directly to the AUSF or indirectly to the AUSF via another network apparatus and has authentication, authorization, and billing functions. The AAA server may be a network apparatus within the core network. Note that the AAA server may not be included in the core network_A and/or the core network_B and may be included in a PLMN and/or an SNPN. In other words, the AAA server may be a core network apparatus or may be an apparatus outside the core network. For example, the AAA server may be a server apparatus within a PLMN and/or an SNPN managed by a 3rd Party.

In the present document, the term “NW” may mean a core network, may mean an access network, or may mean both.

Note that, although each of the apparatuses and functions is illustrated one by one for simplicity in FIG. 2, multiple similar apparatuses and functions may be included in the mobile communication system 1. Specifically, multiple apparatuses and functions such as multiple pieces of UE_A 10, E-UTRANs 80, MMEs 40, SGWs 35, PGW-Us 30, PGW-Cs 32, PCRFs 60, HSSs 50, 5G ANs 120, AMFs 140, UPFs 130, SMFs 132, PCFs 160, and/or UDMs 150 may be included in the mobile communication system 1.

In addition, the mobile communication system 1 may include apparatus(es) and/or function(s) other than the above, and for example, include a Network Slice Selection Function (NSSF)

### 2. Configuration of Each Apparatus

Next, a configuration of each apparatus (the UE, and/or the access network apparatus, and/or the core network apparatus) used in each embodiment will be described with reference to the drawings. Note that each apparatus may be configured as physical hardware, may be configured as logical (virtual) hardware configured in general-purpose hardware, or may be configured as software. In addition, at least a part (including all) of the functions of each apparatus may be configured as physical hardware, logical hardware, or software.

Note that each storage unit (a storage unit_A 340, a storage unit_A 440, a storage unit_B 540, a storage unit_A 640, and a storage unit_B 740) in each apparatus and function to be described later includes, for example, a semiconductor memory, a Solid State Drive (SSD), a Hard Disk Drive (HDD), or the like. Each storage unit can store not only information originally configured at the time of being shipped, but also various pieces of information transmitted and/or received to and/or from apparatuses and functions (for example, the UE, and/or the access network apparatus, and/or the core network apparatus, and/or the PDN, and/or the DN) other than the apparatus and functions of each storage unit. In addition, each storage unit can store identification information, control information, flags, parameters, and the like included in a control message transmitted and/or received in various communication procedures to be described later. In addition, each storage unit may store these pieces of information for each UE. In addition, in a case that each storage unit performs interworking between the 5GS and the EPS, each storage unit can store a control message and user data transmitted and/or received to and/or from the apparatuses and functions included in the 5GS and/or the EPS. In this case, not only data transmitted and/or received over the N26 interface but also data transmitted and/or received without using the N26 interface can be stored.

### 2.1. Apparatus Configuration of UE

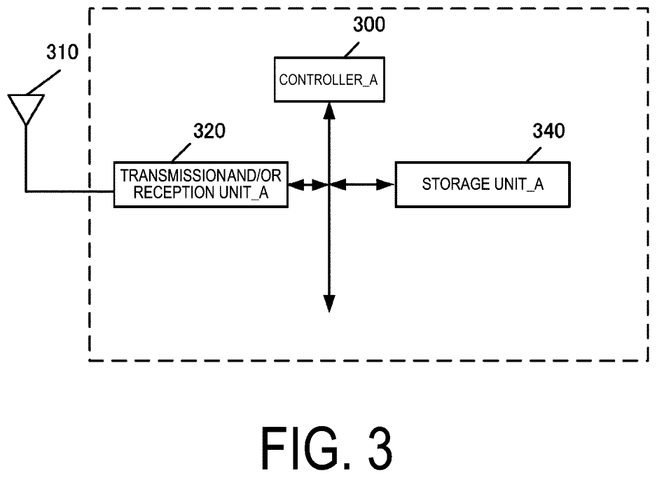

First, an apparatus configuration example of the User Equipment (UE) will be described with reference to FIG. 3. The UE includes a controller_A 300, an antenna 310, a transmission and/or reception unit_A 320, and a storage unit_A 340. The controller_A 300, the transmission and/or reception unit_A 320, and the storage unit_A 340 are connected via a bus. The transmission and/or reception unit_A 320 is connected to the antenna 310.

The controller_A 300 is a function unit that controls overall operations and functions of the UE. The controller_A 300 reads and performs various programs stored in the storage unit_A 340 as necessary, and thereby implements various types of processing in the UE.

The transmission and/or reception unit_A 320 is a function unit that performs radio communication with a base station apparatus (the eNB or the gNB) within the access network via the antenna. In other words, with the use of the transmission and/or reception unit_A 320, the UE can transmit and/or receive user data and/or control information to and/or from the access network apparatus, and/or the core network apparatus, and/or the PDN, and/or the DN.

To provide detailed description with reference to FIG. 2, by using the transmission and/or reception unit_A 320, the UE can communicate with the base station apparatus (eNB) within the E-UTRAN over an LTE-Uu interface. In addition, the UE can communicate with the base station apparatus (gNB) within the 5G AN with the use of the transmission and/or reception unit_A 320. In addition, the UE can transmit and/or receive a Non-Access-Stratum (NAS) message to and/or from the AMF over an N1 interface with the use of the transmission and/or reception unit_A 320. However, the N1 interface is a logical interface, and thus communication between the UE and the AMF is actually performed over the 5G AN.

The storage unit_A 340 is a function unit that stores programs, user data, control information, and the like necessary for each operation of the UE.

### 2.2. Apparatus Configuration of gNB

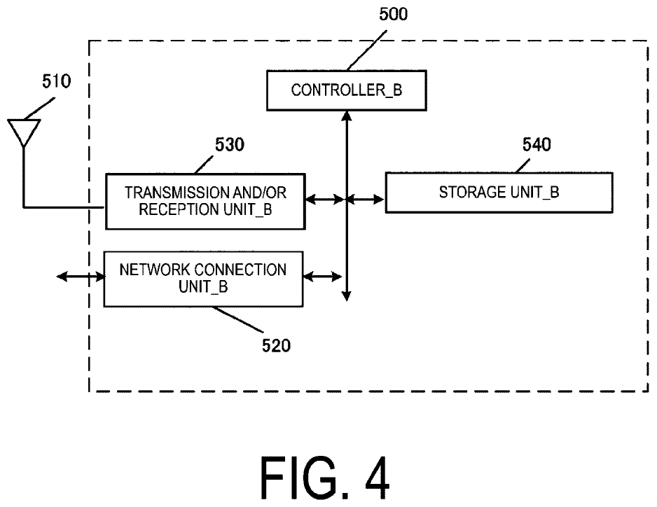

Next, an apparatus configuration example of the gNB will be described with reference to FIG. 4. The gNB includes a controller_B 500, an antenna 510, a network connection unit_B 520, a transmission and/or reception unit_B 530, and a storage unit_B 540. The controller_B 500, the network connection unit_B 520, the transmission and/or reception unit_B 530, and the storage unit B 540 are connected via a bus. The transmission and/or reception unit_B 530 is connected to the antenna 510.

The controller B 500 is a function unit that controls overall operations and functions of the gNB. The controller_B 500 reads and performs various programs stored in the storage unit_B 540 as necessary, and thereby implements various types of processing in the gNB.

The network connection unit_B 520 is a function unit for the gNB to communicate with the AMF and/or the UPF. In other words, with the use of the network connection unit_B 520, the gNB can transmit and/or receive user data and/or control information to and/or from the AMF and/or the UPF.

The transmission and/or reception unit_B 530 is a function unit that performs radio communication with the UE via the antenna 510. In other words, with the use of the transmission and/or reception unit_B 530, the gNB can transmit and/or receive user data and/or control information to and/or from the UE.

To provide detailed description with reference to FIG. 2, by using the network connection unit_B 520, the gNB within the 5G AN can communicate with the AMF over the N2 interface and can communicate with the UPF over the N3 interface. In addition, the gNB can communicate with the UE with the use of the transmission and/or reception unit_B 530.

The storage unit_B 540 is a function unit that stores programs, user data, control information, and the like necessary for each operation of the gNB.

### 2.3. Apparatus Configuration of AMF

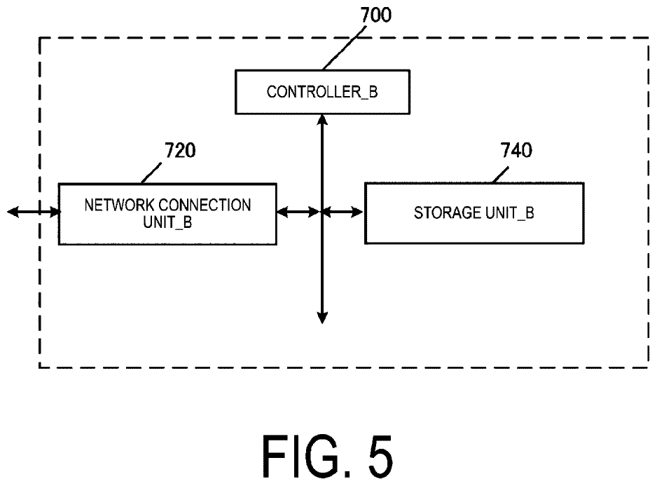

Next, an apparatus configuration example of the AMF will be described with reference to FIG. 5. The AMF includes a controller_B 700, a network connection unit_B 720, and a storage unit B 740. The controller_B 700, the network connection unit_B 720, and the storage unit_B 740 are connected via a bus. The AMF may be a node that handles a control plane.

The controller B 700 is a function unit that controls overall operations and functions of the AMF. The controller_B 700 reads and performs various programs stored in the storage unit B 740 as necessary, and thereby implements various types of processing in the AMF.

The network connection unit_B 720 is a function unit for the AMF to connect to the base station apparatus (gNB) within the 5G AN, and/or the SMF, and/or the PCF, and/or the UDM, and/or an SCEF. In other words, with the use of the network connection unit_B 720, the AMF can transmit and/or receive user data and/or control information to and/or from the base station apparatus (gNB) in the 5G AN, and/or the SMF, and/or the PCF, and/or the UDM, and/or the SCEF.

To provide detailed description with reference to FIG. 2, by using a network connection unit_A 620, the AMF within the 5GCN can communicate with the gNB over the N2 interface, can communicate with the UDM over an N8 interface, can communicate with the SMF over an N11 interface, and can communicate with the PCF over an N15 interface. In addition, the AMF can transmit and/or receive a NAS message to and/or from the UE over the N1 interface with the use of the network connection unit_A 620. However, the N1 interface is a logical interface, and thus communication between the UE and the AMF is actually performed over the 5G AN. In addition, in a case that the AMF supports an N26 interface, the AMF can communicate with the MME over the N26 interface with the use of the network connection unit A 620.

The storage unit_B 740 is a function unit that stores programs, user data, control information, and the like necessary for each operation of the AMF.

Note that the AMF has a function of exchanging a control message with the RAN using the N2 interface, a function of exchanging a NAS message with the UE using the N1 interface, a function of performing encryption and integrity protection of a NAS message, a Registration management (RM) function, a Connection management (CM) function, a Reachability management function, a Mobility management function for the UE or the like, a function of transferring a Session Management (SM) message between the UE and the SMF, an Access Authentication (Access Authorization) function, a security anchor function (Security Anchor Functionality (SEA)), a Security Context Management (SCM) function, a function of supporting the N2 interface for a Non-3GPP Interworking Function (N3IWF), a function of supporting transmission and/or reception of a NAS signal to an/or from the UE via the N3IWF, a function of authenticating the UE connected via the N3IWF, and the like.

In addition, in registration management, an RM state for each UE is managed. The RM state may be synchronized between the UE and the AMF. The RM state includes a deregistered state (RM-DEREGISTERED state) and a registered state (RM-REGISTERED state). In the RM-DEREGISTERED state, because the UE is not registered with the network, the AMF is in a state of being unable to reach the UE, because a UE context in the AMF does not have location information and routing information that are valid for the UE. In addition, in the RM-REGISTERED state, because the UE is registered in the network, the UE can receive a service that requires registration with the network. Note that the RM state may be referred to as a 5GMM state. In this case, the RM-DEREGISTERED state may be referred to as a 5GMM-DEREGISTERED state, and the RM-REGISTERED state may be referred to as a 5GMM-REGISTERED state.

In other words, 5GMM-REGISTERED may be a state in which each apparatus establishes a 5GMM context, or may be a state in which each apparatus establishes a PDU session context. Note that, in a case that each apparatus is in 5GMM-REGISTERED, the UE A 10 may start transmission and/or reception of user data and a control message, or may respond to paging. Furthermore, note that, in a case that each apparatus is in 5GMM-REGISTERED, the UE_A 10 may perform a registration procedure other than a registration procedure for initial registration, and/or a service request procedure.

In addition, 5GMM-DEREGISTERED may be a state in which each apparatus does not establish the 5GMM context, may be a state in which the location information of the UE A 10 is not known to the network, or may be a state in which the network is unable to reach the UE A 10. Note that, in a case that each apparatus is in 5GMM-DEREGISTERED, the UE_A 10 may initiate the registration procedure, or may perform the registration procedure to thereby establish the 5GMM context.

In addition, in connection management, a CM state for each UE is managed. The CM state may be synchronized between the UE and the AMF. The CM state includes a non-connected state (CM-IDLE state) and a connected state (CM-CONNECTED state). In the CM-IDLE state, the UE is in the RM-REGISTERED state, but does not have NAS signaling connection established with the AMF via the N1 interface. In addition, in the CM-IDLE state, the UE has neither connection of the N2 interface (N2 connection) nor connection of the N3interface (N3 connection). On the other hand, in the CM-CONNECTED state, the UE has NAS signaling connection established with the AMF via the N1 interface. In addition, in the CM-CONNECTED state, the UE may have connection of the N2 interface (N2 connection) and/or connection of the N3 interface (N3 connection).

Furthermore, in connection management, management may be performed separately for the CM state in 3GPP access and the CM state in non-3GPP access. In this case, the CM state in 3GPP access may include a non-connected state in 3GPP access (CM-IDLE state over 3GPP access) and a connected state in 3GPP access (CM-CONNECTED state over 3GPP access).

Furthermore, the CM state in non-3GPP access may include a non-connected state in non-3GPP access (CM-IDLE state over non-3GPP access) and a connected state in non-3GPP access (CM-CONNECTED state over non-3GPP access). Note that the non-connected state may be referred to as an idle mode, and a connected state mode may be referred to as a connected mode.

Note that the CM state may be referred to as a 5GMM mode. In this case, the non-connected state may be referred to as a 5GMM non-connected mode (5GMM-IDLE mode), and the connected state may be referred to as a 5GMM connected mode (5GMM-CONNECTED mode). In addition, the non-connected state in 3GPP access may be referred to as a 5GMM non-connected mode in 3GPP access (5GMM-IDLE mode over 3GPP access), and the connected state in 3GPP access may be referred to as a 5GMM connected mode in 3GPP access (5GMM-CONNECTED mode over 3GPP access). In addition, the non-connected state in non-3GPP access may be referred to as a 5GMM non-connected mode in non-3GPP access (5GMM-IDLE mode over non-3GPP access), and the connected state in non-3GPP access may be referred to as a 5GMM connected mode in non-3GPP access (5GMM-CONNECTED mode over non-3GPP access). Note that the 5GMM non-connected mode may be referred to as an idle mode, and the 5GMM connected mode may be referred to as a connected mode.

In addition, one or more AMFs may be deployed within the core network_B. In addition, the AMF may be an NF that manages one or more Network Slice Instances (NSIs). In addition, the AMF may be a common CP function (Common Control Plane Network Function (CPNF)(CCNF)) shared among multiple NSIs.

Note that, in a case that the UE connects to the 5GS over non- 3GPP access, the N3IWF is an apparatus and/or a function deployed between non-3GPP access and the 5GCN.

### 2.4. Apparatus Configuration of SMF

Next, an apparatus configuration example of the SMF will be described with reference to FIG. 5. The SMF includes a controller_B 700, a network connection unit_B 720, and a storage unit B 740. The controller_B 700, the network connection unit_B 720, and the storage unit_B 740 are connected via a bus. The SMF may be a node that handles the control plane.

The controller B 700 is a function unit that controls overall operations and functions of the SMF. The controller_B 700 reads and performs various programs stored in the storage unit B 740 as necessary, and thereby implements various types of processing in the SMF.

The network connection unit_B 720 is a function unit for the SMF to connect to the AMF, and/or the UPF, and/or the PCF, and/or the UDM. In other words, with the use of the network connection unit_B 720, the SMF can transmit and/or receive user data and/or control information to and/or from the AMF, and/or the UPF, and/or the PCF, and/or the UDM.

To provide detailed description with reference to FIG. 2, by using of the network connection unit_A 620, the SMF in the 5GCN can communicate with the AMF over the N11interface, can communicate with the UPF over the N4 interface, can communicate with the PCF over an N7 interface, and can communicate with the UDM over an N10 interface.

The storage unit_B 740 is a function unit that stores programs, user data, control information, and the like necessary for each operation of the SMF.

The SMF has a Session Management function for managing establishment, modification, and release of a PDU session, a function of IP address allocation to the UE and management thereof, a function of selection and control of the UPF, a function of configuring the UPF for routing traffic to an appropriate destination (transmission destination), a function of transmitting and/or receiving an SM part of a NAS message, a function of providing notification of arrival of downlink data (Downlink Data Notification), a function of providing SM information specific to an AN (for each AN) that is transmitted to the AN through the AMF over the N2 interface, a function of determining a Session and Service Continuity mode (SSC mode) for a session, a roaming function, and the like.

### 2.5. Apparatus Configuration of UPF

Next, an apparatus configuration example of the UPF will be described with reference to FIG. 5. The UPF includes a controller_B 700, a network connection unit_B 720, and a storage unit B 740. The controller_B 700, the network connection unit_B 720, and the storage unit_B 740 are connected via a bus. The UPF may be a node that handles the control plane.

The controller B 700 is a function unit that controls overall operations and functions of the UPF. The controller_B 700 reads and performs various programs stored in the storage unit_B 740 as necessary, and thereby implements various types of processing in the UPF.

The network connection unit_B 720 is a function unit for the UPF to connect to the base station apparatus (gNB) within the 5G AN, and/or the SMF, and/or the DN. In other words, with the use of the network connection unit_B 720, the UPF can transmit and/or receive user data and/or control information to and/or from the base station apparatus (gNB) within the 5G AN, and/or the SMF, and/or the DN.

To provide detailed description with reference to FIG. 2, by using the network connection unit_A 620, the UPF within the 5GCN can communicate with the gNB over the N3 interface, can communicate with the SMF over the N4 interface, can communicate with the DN over an N6interface, and can communicate with another UPF over an N9 interface.

The storage unit_B 740 is a function unit that stores programs, user data, control information, and the like necessary for each operation of the UPF.

The UPF has a function as an anchor point (hereinafter, also simply referred to as an anchor) for intra-RAT mobility or inter-RAT mobility, a function as an external PDU session point to be interconnected with the DN (that is, a function of transferring user data as a gateway between the DN and the core network_B), a function of routing and transferring packets, an Uplink Classifier (UL CL) function of supporting routing of multiple traffic flows for one DN, a Branching point function of supporting a multi-homed PDU session, a Quality of Service (QOS) processing function for the user plane, a function of verifying uplink traffic, a function of triggering buffering of downlink packets and Downlink Data Notification, and the like. The UPF may also be referred to as an anchor or a PDU session anchor or an endpoint.

In addition, the UPF may be a gateway for IP communication and/or non-IP communication. In addition, the UPF may have a function of transferring IP communication, or a function of conversion between non-IP communication and IP communication. Furthermore, multiple deployed gateways may be gateways for connecting the core network_B and a single DN. Note that the UPF may have connectivity with another NF, and may be connected to each apparatus via another NF.

Note that a user plane refers to user data that is transmitted and/or received between the UE and a network. The user plane may be transmitted and/or received using a PDN connection or a PDU session. Furthermore, in a case of the EPS, the user plane may be transmitted and/or received using an LTE-Uu interface, and/or an S1-U interface, and/or an S5 interface, and/or an S8 interface, and/or an SGi interface. Furthermore, in a case of the 5GS, the user plane may be transmitted and/or received over the interface between the UE and the NG RAN, and/or the N3 interface, and/or the N9 interface, and/or the N6 interface. The user plane may be hereinafter referred to as a U-Plane.

In addition, a control plane refers to a control message that is transmitted and/or received in order to perform communication control of the UE or the like. The control plane may be transmitted and/or received using Non-Access-Stratum (NAS) signaling connection between the UE and the MME. In addition, in a case of the EPS, the control plane may be transmitted and/or received using the LTE-Uu interface and an S1-MME interface. Furthermore, in a case of the 5GS, the control plane may be transmitted and/or received using the interface between the UE and the NG RAN and the N2 interface. The control plane may be hereinafter referred to as a control plane, or may be hereinafter referred to as a C-Plane.

Furthermore, the U-Plane (User Plane (UP)) may be a communication path for transmitting and/or receiving user data, and may include multiple bearers. Furthermore, the C-Plane (Control Plane (CP)) may be a communication path for transmitting and/or receiving a control message, and may include multiple bearers.

### 2.6. Other Apparatuses and/or Functions and/or Terminology in Present Embodiment

Next, other apparatuses and/or functions and/or terminology and/or identification information transmitted and/or received, stored, and managed by each apparatus and/or messages will be described.

A network refers to at least some of the access network_B, the core network_B, and the DN. One or more apparatuses included in at least a part of the access network_B, the core network_B, and the DN may be referred to as a network or a network apparatus. In other words, “a network transmits and/or receives a message and/or performs processing” may mean “an apparatus (a network apparatus and/or a control apparatus) in the network transmits and/or receives the message and/or performs the processing”. Conversely, “an apparatus in a network transmits and/or receives a message and/or performs processing” may mean “the network transmits and/or receives the message and/or performs the processing”.

A session management (SM) message (also referred to as a Non-Access-Stratum (NAS) SM message) may be a NAS message used in a procedure for SM, or may be a control message transmitted and/or received between the UE_A 10 and the SMF_A 230 via the AMF A 240. Furthermore, the SM message may include a PDU session establishment request message, a PDU session establishment accept message, a PDU session reject message (PDU session establishment reject message), a PDU session modification request message, a PDU session modification command message, a PDU session modification completion message (PDU session modification complete), a PDU session modification command reject message, a PDU session modification reject message, a PDU session release request message, a PDU session release reject message, a PDU session release command message, a PDU session release complete message, and the like.

The procedure for SM or the SM procedure may include a PDU session establishment procedure, a PDU session modification procedure, and a PDU session release procedure (UE-requested PDU session release procedure). Note that each procedure may be a procedure initiated by the UE, or may be a procedure initiated by the network (NW).

A Mobility management (MM) message (also referred to as a NAS MM message) may be a NAS message used in a procedure for MM, or may be a control message transmitted and/or received between the UE_A 10 and the AMF_A 240. Furthermore, the MM message may include a Registration request message, a Registration accept message, a Registration reject message, a De-registration request message, a De-registration accept message, a configuration update command message, a configuration update complete message, a Service request message, a Service accept message, a Service reject message, a Notification message, a Notification response message, and the like.

The procedure for MM or the MM procedure may include a Registration procedure, a De-registration procedure, a Generic UE configuration update procedure, an authentication and authorization procedure, a Service request procedure, a Paging procedure, and a Notification procedure.

A 5G System (5GS) service may be a connection service provided using the core network B 190. In addition, the 5GS service may be a service different from an EPS service, or may be a service similar to the EPS service.

A non 5GS service may be a service other than the 5GS service and may include an EPS service and/or a non EPS service.

A Packet Data Network (PDN) type indicates a type of PDN connection and includes IPv4, IPv6, IPv4v6, and non-IP. In a case that IPv4 is specified, it indicates that transmission and/or reception of data is performed using IPv4. In a case that IPv6 is specified, it indicates that transmission and/or reception of data is performed using IPv6. In a case that IPv4v6 is specified, it is indicated that transmission and/or reception of data is performed using IPv4 or IPv6. In a case that non-IP is specified, it is indicated that communication is performed using a communication method other than the IP, not communication using the IP.

Although a Protocol Data Unit (PDU) session can be defined as a relationship between the DN that provides a PDU connectivity service and the UE, the PDU session may be connectivity established between the UE and an external gateway. In the 5GS, the UE establishes a PDU session via the access network_B and the core network_B, and can thereby perform transmission and/or reception of user data to and/or from the DN by using the PDU session. Here, the external gateway may be a UPF, an SCEF, or the like. The UE can perform transmission and/or reception of user data to and/or from an apparatus deployed in the DN, such as an application server, by using a PDU session.

Note that each apparatus (the UE, and/or the access network apparatus, and/or the core network apparatus) may associate one or more pieces of identification information with a PDU session for management. Note that these pieces of identification information may include one or more of a DNN, a QoS rule, a PDU session type, application identification information, NSI identification information, access network identification information, and an SSC mode (also referred to as an SSC mode), and may further include other pieces of information. In addition, in a case that multiple PDU sessions are established, pieces of identification information associated with the PDU sessions may have the same or different details.

The Data Network Name (DNN) may be identification information for identifying the core network and/or an external network such as the DN. In addition, the DNN can also be used as information for selecting a gateway such as the PGW_A 30/UPF_A 235 connecting the core network B 190. In addition, the DNN may correspond to an Access Point Name (APN).

A Protocol Data Unit/Packet Data Unit (PDU) session type indicates a type of PDU session and includes IPv4, IPv6, Ethernet, and Unstructured. In a case that IPv4 is specified, it indicates that transmission and/or reception of data is performed using IPv4. In a case that IPv6 is specified, it indicates that transmission and/or reception of data is performed using IPv6. In a case that Ethernet is specified, it indicates that transmission and/or reception of an Ethernet frame is performed. Alternatively, Ethernet may indicate that communication using the IP is not performed. In a case that Unstructured is specified, it indicates that data is transmitted and/or received to and/or from an application server in the DN or the like by using a Point-to-Point (P2P) tunneling technique. For the P2P tunneling technique, for example, a UDP/IP encapsulation technique may be used. Note that the PDU session type may include the IP, in addition to the above. The IP can be specified in a case that the UE can use both of IPv4 and IPV6.

The Public land mobile network (PLMN) is a communication network that provides mobile radio communication services. The PLMN is a network managed by an operator who is a (mobile) network operator, and the operator can be identified by a PLMN ID. In the present document, the PLMN may mean the PLMN ID. A PLMN that matches a Mobile Network Code (MNC) and a Mobile Country Code (MCC) of an International Mobile Subscriber Identity (IMSI) of the UE may be a Home PLMN (HPLMN). The PLMN may mean a core network.

Furthermore, the UE may hold, in a USIM, an Equivalent HPLMN list for identifying one or more Equivalent HPLMNs (EHPLMNs). A PLMN different from the HPLMN and/or the EHPLMN may be a Visited PLMN (VPLMN).

The PLMN that the UE has successfully registered may be a Registered PLMN (RPLMN). Each apparatus may receive and/or hold and/or store, from the RPLMN, an Equivalent PLMN list for identifying one or more Equivalent PLMNs (EPLMNs) that can be used equivalently to the RPLMN in the PLMN selection performed by the UE.

The current PLMN may be a PLMN requested by the UE and/or a PLMN selected by the UE and/or the RPLMN and/or the PLMN allowed by the network and/or the PLMN to which the core network apparatus transmitting and/or receiving messages belongs to.

The requested PLMN means a message transmission destination network in a case that the UE transmits a message. Specifically, the requested PLMN may be a PLMN selected by the UE in a case that the UE transmits a message. The requested PLMN is the PLMN requested by the UE and may be a current PLMN. Also, the requested PLMN may be a registered PLMN in a case that the UE is in a registered state.

A Non-public network (NPN) is a network intended for non-public specifications. There are two types of NPN including a Stand-alone non-public network (SNPN) and a Public network integrated non-public network (PNI-NPN). The SNPN and PNI-NPN may be deployed in the 5GS. In the present document, in a case that NPN is referred to, it may mean an SNPN or a PNI-NPN or both.

A Stand-alone non-public network (SNPN) is a network that is operated by an NPN operator and does not depend on the network functions provided by a PLMN. In other words, an SNPN is a network independent of a PLMN and can only be accessed by certain UEs. The SNPN is identified with a PLMN ID and a Network identifier (NID).

Here, a PLMN ID for identifying an SNPN does not need to be unique. For example, one or more PLMN IDs reserved to be used in a private network may be used for an NPN.

A Stand-alone Non-Public Network (SNPN) is a network that is identified by an SNPN ID composed of a combination of a PLMN ID and a Network identifier (NID) and to which only specific UE is allowed to connect. The SNPN may mean a core network. Here, the UE that is allowed to access the SNPN may be an SNPN enabled UE.

Furthermore, the UE may hold, in the USIM, an Equivalent SNPN list for identifying one or more Equivalent SNPNs (ESNPNs). An SNPN different from a HSNPN and/or an ESNPN may be a Visited PLMN (VPLMN).

The SNPN with which the UE has been successfully registered may be a Registered SNPN (RSNPN). Each apparatus may receive and/or hold and/or store, from the RSNPN, Equivalent SNPN list for identifying one or more Equivalent PLMNs (ESNPNs) that can be used equivalently to the RSNPN in the PLMN selection or SNPN selection performed by the UE.

A Public network integrated non-public network (PNI-NPN) is an NPN deployed with support of a PLMN. In other words, it is a network that uses the functions of a PLMN to implement private specifications.

Onboarding services in SNPN allow an MS (UE) to access the SNPN indicating onboarding using default UE credentials.

A registration procedure for onboarding services in SNPN may be an Initial registration for onboarding services in SNPN. Additionally or alternatively, the registration procedure for an onboarding service in SNPN may be a registration procedure for registration update due to mobility in a case that a UE has been registered for the onboarding service in SNPN. The registration procedure for an onboarding service in SNPN may be referred to as SNPN onboarding registration.

In the registration procedure for an onboarding service in SNPN, MM-based slice admission control may not be performed by the AMF or the NF in the core network for the S-NSSAI for the onboarding service in SNPN.

The onboarding services in the SNPN may allow the UE to connect to the SNPN indicating that onboarding is allowed by using default UE credentials for primary authentication so that the UE includes one or more entries of a “list of subscriber data”. Note that the onboarding services in the SNPN may be referred to as onboarding services, or may be referred to as onboarding.

In a case that the UE is registered for onboarding services in the SNPN, services other than the onboarding services in the SNPN may be unavailable. In a case that the UE is not registered for onboarding services in the SNPN, the onboarding services in the SNPN may be unavailable.

Here, the UE performing registration for onboarding services in the SNPN may mean the UE indicating SNPN onboarding registration in a 5GS registration type information element. Note that the registration procedure for onboarding services may be referred to as an onboarding procedure.

Next, an Onboarding Network (ON) may be a network for which onboarding is allowed. The onboarding network may be a network that provides initial registration and/or access to the UE for onboarding. Note that the onboarding network may be referred to as an ONN.

Here, the onboarding network may be a PLMN, and may be referred to as an ON-PLMN. Furthermore, the onboarding network may be an SNPN, and may be referred to as an ON-SNPN (onboarding SNPN).

The onboarding network may be a PLMN or an onboarding SNPN that enables a registered UE to perform Remote Provisioning.

Next, a Provisioning Server is an entity that provides credentials to the UE to enable SNPN connection.

Here, the provisioning server may be present in the onboarding network. Furthermore, the provisioning server may be present in an external DN different from the onboarding network.

Next, a Subscription Owner SNPN (SO-SNPN) may be an SNPN having a subscription of the UE. The SO-SNPN may be an SNPN that provides subscription data to the UE via the provisioning server during the onboarding procedure. Note that the ON-SNPN and the SO-SNPN may be the same SNPN, or may be different SNPNs.

In addition, a network slice (NS) is a logical network that provides specific network capability and network characteristics. The UE and/or the network can support the network slice (NW slice (NS)) in the 5GS. The network slice may be referred to simply as a slice.

In addition, a network slice instance (NSI) includes a set of an instance (entity) of a network function (NF) and necessary resources and forms a network slice to be mapped. Here, the NF is a processing function for a network, and is adopted or defined by the 3GPP. The NSI is an entity of one or more NSs configured in the core network_B. In addition, the NSI may include a virtual Network Function (NF) generated using a Network Slice Template (NST).

Here, the NST is associated with a resource request for provision of a requested communication service and capability, and is a logical expression of one or more NFs. In other words, the NSI may be a set of multiple NFs on the core network_B 190. The NSI may be a logical network configured for classifying user data to be delivered depending on a service or the like. In the NS, one or more NFs may be configured. Each NF configured in the NS may or may not be an apparatus shared with another NS.

The UE and/or the apparatus in the network can be allocated to one or more NSs, based on an NSSAI, and/or an S-NSSAI, and/or a UE usage type, and/or registration information such as one or more NSI IDs, and/or an APN. Note that the UE usage type is a parameter value included in registration information of the UE, which is used for identifying the NSI. The UE usage type may be stored in the HSS. The AMF may select the SMF and the UPF based on the UE usage type.

In addition, Single Network Slice Selection Assistance Information (S-NSSAI) is information for identifying the NS. The S-NSSAI may include only a Slice/Service type (SST), or may include both of an SST and a Slice Differentiator (SD). Here, the SST is information indicating an operation of the NS expected in terms of functions and services. In addition, the SD may be information for interpolating an SST in a case that one NSI is selected out of multiple NSIs indicated by the SST. The S-NSSAI may be information unique to each PLMN or SNPN or may be standard information common to PLMNs or SNPNs.

The S-NSSAI may also be transmitted and/or received between apparatuses using S-NSSAI IEs of the 5GS. In that case, the S-NSSAI may include S-NSSAI (SST and/or SD) associated with the current PLMN or SNPN and/or S-NSSAI (SST and/or SD) of an HPLMN (if any, for example, in a case that the UE performs roaming or in a case that the current PLMN or SNPN is a VPLMN or an SNPN).

In addition, a network may store one or more pieces of S-NSSAI in the registration information of the UE as default S-NSSAI. Note that, in a case that the S-NSSAI is default S-NSSAI and the UE does not transmit, to a network, valid S-NSSAI in a registration request message, the network may provide an NS related to the UE.

In addition, the S-NSSAI transmitted and/or received between the UE and the NW may be referred to as an S-NSSAI Information element (IE). Furthermore, an S-NSSAI IE transmitted and/or received between the UE and the NW may include S-NSSAI including the SST and/or SD of the registered PLMN or SNPN and/or the SST and/or SD indicating S-NSSAI of the HPLMN or HSNPN to which the aforementioned S-NSSAI is mapped. One or more pieces of S-NSSAI stored in the UE and/or the NW may include the SST and/or the SD, or include the S-NSSAI including the SST and/or the SD and/or the SST and/or the SD indicating the S-NSSAI of the HPLMN to which the S-NSSAI is mapped.

In addition, the Network Slice Selection Assistance Information (NSSAI) is a set of pieces of the S-NSSAI. Each piece of the S-NSSAI included in the NSSAI is information for assisting the access network or the core network to select an NSI. The UE may store the NSSAI allowed by the network for each PLMN or SNPN. In addition, the NSSAI may be information used for selecting the AMF. The UE may apply, to the PLMN and EPLMN or the SNPN and ESNPN, each piece of NSSAI (allowed NSSAI and/or configured NSSAI and/or rejected NSSAI and/or pending NSSAI).

The mapped S-NSSAI is the S-NSSAI of the HPLMN mapped to the S-NSSAI of the registered PLMN in a roaming scenario. The UE may store one or more pieces of mapped S-NSSAI mapped to the S-NSSAI included in the configured NSSAI and the allowed NSSAI of each access type. Furthermore, the UE may store one or more pieces of mapped S-NSSAI of the S-NSSAI included in the rejected NSSAI and/or the pending NSSAI.

In a case that the SNPN roaming scenario is supported, the mapped S-NSSAI may be S-NSSAI of the HSNPN mapped to the S-NSSAI of the registered SNPN.

A Network Slice-Specific Authentication and Authorization (NSSAA) function is a function for implementing network slice-specific authentication and authorization. The network slice-specific authentication and authorization allows the UE to be authenticated and authorized outside the core network, such as in a 3rd Party. The PLMN or the SNPN and the network apparatus having the NSSAA function can perform an NSSAA procedure on certain S-NSSAI, based on registration information of the UE. Furthermore, the UE having the NSSAA function can manage, store, and transmit and/or receive the pending NSSAI and the third rejected NSSAI. In the present document, NSSAA may be referred to as a network slice-specific authentication and authorization procedure or an authentication and authorization procedure.

The S-NSSAI that requires NSSAA is S-NSSAI that requires NSSAA managed by the core network and/or the core network apparatus. Furthermore, at the time of roaming, the S-NSSAI requiring the NSSAA may be S-NSSAI other than that of the HPLMN or HSNPN, which is managed by the core network and/or the core network apparatus, and in which the S-NSSAI of the HPLMN or HSNPN requiring the NSSAA is mapped S-NSSAI.

The core network and/or the core network apparatus may store the S-NSSAI that requires NSSAA by associating the S-NSSAI with information indicating whether NSSAA is required.

Furthermore, the core network and/or the core network apparatus may store the S-NSSAI requiring the NSSAA in association with information indicating whether NSSAA has completed or information indicating that NSSAA has completed and been allowed or succeeded. The core network and/or the core network apparatus may manage the S-NSSAI requiring NSSAA as information unrelated to the access network.

In addition, configured NSSAI is NSSAI provided and stored in the UE. The UE may store the configured NSSAI for each PLMN or SNPN. The UE may store the configured NSSAI in association with the PLMN or SNPN.

Note that, in the present document, the configured NSSAI associated with the PLMN may be referred to as configured NSSAI with respect to the PLMN, configured NSSAI of the PLMN, configured NSSAI for the PLMN, or configured NSSAI associated with the PLMN. Similarly, the configured NSSAI associated with the SNPN may be expressed as configured NSSAI with respect to the SNPN, configured NSSAI of the SNPN, configured NSSAI for the SNPN, or configured NSSAI associated with the SNPN.

In addition, the UE may store configured NSSAI that is not associated with the PLMN and is valid for all PLMNs, and such configured NSSAI may be defined as “default configured NSSAI”. Similarly, the UE may store configured NSSAI that is not associated with the SNPN and is valid for all SNPNs, and such configured NSSAI may be defined as “default configured NSSAI”. The UE may store configured NSSAI that is associated with neither the PLMN nor the SNPN and is valid for all PLMNs and SPNMs, and such configured NSSAI may be defined as “default configured NSSAI”.

The configured NSSAI may be associated with multiple PLMNs or SNPNs, these multiple PLMNs may be EPLMNs, or multiple SNPNs may be ESNPNs.

The configured NSSAI may be information configured by a network (or a PLMN or an SNPN). The S-NSSAI included in the configured NSSAI may be referred to as configured S-NSSAI. The configured S-NSSAI may be transmitted and/or received using S-NSSAI IEs, and in this case, the configured S-NSSAI may include S-NSSAI (SST and/or SD) and mapped S-NSSAI (SST of mapped HPLMN or the SNPN and/or SD of mapped HPLMN or SNPN) (if any, for example, in a case that the UE performs roaming or in a case that associated PLMN or SNPN is a VPLMN or a VSNPN).

Alternatively, the S-NSSAI (SST and/or SD) of the PLMN or the SNPN and the S-NSSAI (SST and/or SD) of the HPLMN or the SNPN may be treated independently. Specifically, the configured S-NSSAI of the PLMN or the SNPN may be referred to as “configured S-NSSAI for the PLMN or the SNPN” or “configured S-NSSAI of the PLMN or the SNPN” or “configured S-NSSAI with respect to the PLMN or the SNPN”.

Furthermore, one or more pieces of S-NSSAI of the HPLMN or the HSNPN to which the configured S-NSSAI is mapped may be referred to as “one or more pieces of mapped S-NSSAI with respect to the configured NSSAI of the PLMN or the SNPN” or “one or more pieces of mapped S-NSSAI of the configured NSSAI of the PLMN or the SNPN”.

In other words, the UE may store “configured NSSAI of the current PLMN or SNPN” included in the S-NSSAI of the current PLMN or SNPN, and further during roaming, the UE may store “one or more pieces of mapped S-NSSAI with respect to the configured NSSAI of the current PLMN or SNPN”. The one or more pieces of mapped S-NSSAI with respect to the configured NSSAI may be mapped S-NSSAI(s) for the configured NSSAI of the 3GPP.

The configured NSSAI may be updated by the NW at an arbitrary timing, and the updated configured NSSAI may be transmitted from the NW to the UE based on the update.

In addition, requested NSSAI is NSSAI provided to the network from the UE during the registration procedure. In the registration procedure, the S-NSSAI included in the requested NSSAI transmitted by the UE may be S-NSSAI included in the allowed NSSAI or the configured NSSAI stored in the UE.

The requested NSSAI may be information indicating a network slice requested by the UE. The S-NSSAI included in the requested NSSAI may be referred to as requested S-NSSAI. For example, the requested NSSAI is included and transmitted and/or received in a Non-Access-Stratum (NAS) message transmitted from the UE to the network, such as a registration request message or a PDU session establishment request message, or in a Radio Resource Control (RRC) message including the NAS message. Here, in a roaming case, the requested NSSAI may include S-NSSAI of a VPLMN and the S-NSSAI of a mapped HPLMN. In other words, the S-NSSAI included in the requested NSSAI (requested S-NSSAI) may include S-NSSAI and mapped S-NSSAI.

The requested NSSAI may be information including one or more pieces of S-NSSAI associated with a network slice requested by the UE. Note that the network slice requested by the UE may be a network slice that the UE wants to use, or a network slice that the UE requests to be allowed to use by the network. The S-NSSAI included in the requested NSSAI may be S-NSSAI included in the configured NSSAI associated with the current PLMN, or may be S-NSSAI included in allowed NSSAI associated with the current PLMN.

In other words, requested NSSAI may be S-NSSAI included in the configured NSSAI associated with one or more current PLMNs, S-NSSAI included in the allowed NSSAI associated with one or more current PLMNs, or a combination of the two configurations described above. More specifically, the allowed NSSAI associated with the current PLMN may be allowed NSSAI associated with the current PLMN and the current access type. Furthermore, the requested NSSAI may be requested NSSAI of the 5GS.

Note that, the S-NSSAI included in the requested NSSAI may be S-NSSAI that is stored in the UE but not included in the rejected NSSAI associated with the current PLMN or SNPN, and/or S-NSSAI that is stored in the UE but not included in pending NSSAI associated with the current PLMN or SNPN, or S-NSSAI that is stored in the UE but not included in the fourth rejected NSSAI associated with the current PLMN or SNPN.

Furthermore, the S-NSSAI included in the requested NSSAI may be S-NSSAI for which the back-off timer associated with the S-NSSAI and/or the mapped S-NSSAI of the S-NSSAI is not running for the UE.

In addition, the allowed NSSAI is information indicating one or more network slices allowed for the UE. In other words, the allowed NSSAI is information identifying a network slice to which the UE is allowed to connect by the network. The allowed NSSAI may be allowed NSSAI stored in the UE and/or the NW, or allowed NSSAI transmitted from the NW to the UE. In this case, the allowed NSSAI may refer to an allowed NSSAI IE of the 3GPP.

The allowed NSSAI IE transmitted from the NW to the UE may include a list of pieces of the S-NSSAI of the current PLMN or SNPN that are valid for the current PLMN or SNPN at the time of non-roaming.

At the time of roaming, the allowed NSSAI IE transmitted from the NW to the UE may include a list of pieces of the S-NSSAI of the current PLMN or SNPN that are valid for the current PLMN or SNPN and also a list of pieces of mapped S-NSSAI that is the S-NSSAI of the HPLMN or HSNPN to which the S-NSSAI of the current PLMN or SNPN is further mapped.

Note that the list of pieces of S-NSSAI of the current PLMN or SNPN that are included in the allowed NSSAI IE and are valid for the current PLMN or SNPN may be referred to as Allowed NSSAI, and the list of pieces of mapped S-NSSAI that are S-NSSAI of the HPLMN or HSNPN to which the S-NSSAI of the current PLMN or SNPN is mapped may be referred to as a list of pieces of mapped S-NSSAI of the Allowed NSSAI. Here, the list of pieces of mapped S-NSSAI of the Allowed NSSAI may be mapped S-NSSAI(s) for the allowed NSSAI for a PLMN of the 3GPP. Similarly, the Allowed NSSAI may mean allowed NSSAI for a PLMN or an SNPN of the 3GPP.

The UE and/or the NW may store and manage the allowed NSSAI for each access (the 3GPP access or the non-3GPP access), as information regarding the UE. The UE and/or the NW may further manage the allowed NSSAI in association with the registration area.

Furthermore, the UE and/or the NW may store and manage the allowed NSSAI in association with the PLMN or the SNPN as information regarding UE. The allowed NSSAI may be associated with multiple PLMN, these multiple PLMNs may be EPLMNs, or multiple SNPNs may be ESNPNs.

Note that, in the present document, the allowed NSSAI associated with the PLMN or SNPN and the access type may be referred to as “allowed NSSAI with respect to the PLMN or SNPN and the access type” or “allowed NSSAI with respect to the access type of the PLMN or SNPN”.

The S-NSSAI included in the allowed NSSAI may be referred to as an allowed S-NSSAI. The allowed S-NSSAI may be transmitted and/or received using S-NSSAI IEs, and in this case, the allowed S-NSSAI (SST and/or SD) may include S-NSSAI and mapped S-NSSAI (SST of mapped HPLMN or the SNPN and/or SD of mapped HPLMN or SNPN) (if any, for example, in a case that the UE performs roaming or in a case that associated PLMN or SNPN is a VPLMN or a VSNPN).

Alternatively, the S-NSSAI (SST and/or SD) of the PLMN or the SNPN and the S-NSSAI) of the HPLMN or the SNPN (SST of the mapped HPLMN or SNPN and/or SD of the mapped HPLMN or SNPN may be treated independently. Specifically, the Allowed S-NSSAI of the PLMN or the SNPN may be expressed as “allowed S-NSSAI for the PLMN or the SNPN ” or “allowed S-NSSAI of the PLMN or the SNPN ” or “allowed S-NSSAI with respect to the PLMN or the SNPN ”.

Furthermore, one or more pieces of S-NSSAI of the HPLMN or the HSNPN to which the allowed S-NSSAI is mapped may be referred to as “one or more pieces of mapped S-NSSAI with respect to the allowed NSSAI of the PLMN or the SNPN” or “one or more pieces of mapped S-NSSAI of the allowed NSSAI of the PLMN or the SNPN”.

In addition, the rejected NSSAI is information indicating one or more network slices not allowed for the UE to use or request. In other words, the rejected NSSAI is information identifying a network slice to which the UE is not allowed to connect by the network. The rejected NSSAI transmitted from the NW to the UE may be included in a rejected NSSAI IE or an Extended rejected NSSAI IE.

The rejected NSSAI transmitted and/or received by using the rejected NSSAI IE may be information including one or more combinations of S-NSSAI (SST and/or SD) and a rejection cause value (rejected S-NSSAI). The rejected NSSAI transmitted and/or received using an Extended rejected NSSAI IE may be, during roaming, information including one or more combinations (Rejected S-NSSAI) of S-NSSAI (SST and/or SD) and mapped S-NSSAI (SST of the mapped HPLMN or SNPN and/or SD of the mapped HPLMN or SNPN) (if any, for example, at a time in a case that the UE performs roaming, or in a case that the associated PLMN or SNPN is the VPLMN or VSNPN) and the rejection cause value.

The Extended rejected NSSAI IE may include one or more sets of Rejected S-NSSA and/or NSSAI (Partial extended rejected NSSAI list in the 5GS), and the set of Rejected S-NSSAI may include information indicating the type of the set.

The information indicating the type of the set may be, for example, information indicating that the set includes one or more pieces of rejected S-NSSAI (SST and/or SD) with associated back-off timer values, or information indicating that the set does not include associated back-off timer values but includes one or more pieces of rejected S-NSSAI (SST and/or SD).

In a case that the information indicating the type of the set is information indicating that one or more pieces of rejected S-NSSAI are included in the set together with the associated back-off timer value, the set of Rejected S-NSSAI may include the back-off timer value.

Here, the S-NSSAI included in the rejected NSSAI may be associated with a PLMN ID or an SNPN ID. Note that a PLMN or an SNPN indicated by a PLMN ID or an SNPN ID with which the S-NSSAI included in the rejected NSSAI is associated may be the current PLMN or the current SNPN. Alternatively, the PLMN ID or the SNPN ID with which the S-NSSAI included in the rejected NSSAI is associated may be information indicating the HPLMN or the HSNPN regardless of the current PLMN or SNPN.

Here, the rejection cause value is information indicating the reason that the network rejects the corresponding S-NSSAI or a combination (if any) of the corresponding S-NSSAI and the mapped S-NSSAI. The UE and/or network may store and manage each piece of S-NSSAI and/or mapped S-NSSAI (if any) as appropriate rejected NSSAI and/or mapped S-NSSAI of the rejected NSSAI based on the rejection cause value with which each S-NSSA or a combination of the corresponding S-NSSAI and the mapped S-NSSAI is associated.

Furthermore, the rejected NSSAI may be included in the NAS message transmitted from the network to the UE, such as a registration accept message, a configuration update command, or a registration reject message, or in an RRC message including a NAS message. The S-NSSAI included in the rejected NSSAI may be referred to as rejected S-NSSAI.

The rejected NSSAI may be transmitted by using a Rejected NSSAI IE or may be transmitted by using an Extended rejected NSSAI IE in a case that the UE is roaming. The Extended rejected NSSAI IE may include one or more pieces rejected S-NSSAI (IE) including the S-NSSAI of the current PLMN or SNPN (SST and/or SD), the mapped S-NSSAI (SST of the mapped HPLMN or SNPN and/or SD of the mapped HPLMN or SNPN) and the rejection cause value, and it may be understood that the UE has been rejected to request the received S-NSSAI of the current PLMN or SNPN to the NW together with the received mapped S-NSSAI. Meanwhile, the Rejected NSSAI IE may include the rejected S-NSSAI IE according to the S-NSSAI of the current PLMN or SNPN and the rejection cause value, and it may be understood that the UE has been rejected to request the received S-NSSAI of the current PLMN or SNPN or S-NSSAI associated with the S-NSSAI of the HPLMN or HSNPN from the NW.

The rejected NSSAI may be any one of the first to fifth rejected NSSAI, one or more pieces of mapped S-NSSAI with respect to the rejected NSSAI, one or more pieces of mapped S-NSSAI with respect to the second rejected NSSAI, one or more pieces of mapped S-NSSAI with respect to the fourth rejected NSSAI, and one or more pieces of mapped S-NSSAI with respect to the fifth rejected NSSAI, or may be a combination thereof. The S-NSSAI included in the rejected NSSAI may be referred to as rejected S-NSSAI. The rejected S-NSSAI may be transmitted and/or received between apparatuses by using S-NSSAI IEs, and an S-NSSAI IE indicating the rejected NSSAI may include S-NSSAI and mapped S-NSSAI.

The UE and/or the NW may store and manage the rejected NSSAI in association with the PLMN or the SNPN as information regarding the UE. The rejected NSSAI may be further associated with the other one or more PLMNs or SNPNs, and the other one or more PLMNs may be EPLMNs, and the other one or more SNPNs may be ESNPNs.

Note that, in the present document, the rejected NSSAI associated with the PLMN or the SNPN may be referred to as rejected NSSAI with respect to the PLMN or the SNPN, rejected NSSAI of the PLMN or the SNPN, or rejected NSSAI for the PLMN or the SNPN. The UE and/or the NW may further store second rejected NSSAI and/or second rejected S-NSSAI in association with a registration area. The UE and/or the NW may store the second rejected NSSAI and/or the second rejected S-NSSAI in association with an access type and/or a registration area.

Here, the first rejected NSSAI is a set of one or more pieces of the S-NSSAI available in the current PLMN or the current SNPN. The first rejected NSSAI may be rejected NSSAI for the current PLMN or SNPN in the 5GS, may be rejected S-NSSAI for the current PLMN or SNPN, may be S-NSSAI included in the rejected NSSAI for the current PLMN or SNPN, may be mapped S-NSSAI(s) for rejected S-NSSAI for the current PLMN or SNPN, or may be S-NSSAI included in mapped S-NSSAI(s) for rejected S-NSSAI for the current PLMN or SNPN. The list (set) of pieces of mapped S-NSSAI of the first rejected NSSAI may be one or more pieces of mapped S-NSSAI with respect to the first rejected NSSAI or mapped S-NSSAI(s) for the rejected NSSAI for the current PLMN or SNPN of the 5GS. The first rejected NSSAI may be rejected NSSAI stored by the UE or the NW or may be rejected NSSAI transmitted from the NW to the UE.

In a case that the first rejected NSSAI is rejected NSSAI transmitted from the NW to the UE, one or more pieces of S-NSSAI rejected because they are unavailable in the current PLMN or the current SNPN among pieces of the S-NSSAI included in the requested NSSAI transmitted from the UE to the NW are included. In this case, the first rejected NSSAI may be information including one or more combinations of the S-NSSAI and the rejection cause value. The rejection cause value at this time may be “S-NSSAI not available in the current PLMN or SNPN” or may be information indicating that the S-NSSAI associated with the rejection cause value is not available in the current PLMN or SNPN. The S-NSSAI included in the first rejected NSSAI may be referred to as first rejected S-NSSAI.

In a case that the first rejected NSSAI is rejected NSSAI transmitted from the NW to the UE, the first rejected NSSAI may be included and transmitted and/or received in the rejected NSSAI IE or the Extended rejected NSSAI IE. The rejected NSSAI IE or the Extended rejected NSSAI IE may include at least one combination of the S-NSSAI of the current PLMN or SNPN and the rejection cause value. In a case that the UE is roaming, the foregoing combination may further include mapped S-NSSAI that is S-NSSAI of the HPLMN.

In other words, in a roaming case, the first rejected NSSAI transmitted from the NW to the UE may include at least one combination of the S-NSSAI of the current PLMN or SNPN, the mapped S-NSSAI, and the rejection cause value.

The first rejected NSSAI may be applied to all of registered PLMNs or SNPNs. The UE and/or NW may handle the first rejected NSSAI and the S-NSSAI included in the first rejected NSSAI as information regardless of the access type. In other words, the first rejected NSSAI may be information valid for 3GPP access and non-3GPP access.

In a case that the UE transitions to a deregistered state on both the 3GPP access and the non-3GPP access for the current PLMN, the UE may remove the first rejected NSSAI from storage. In other words, the UE removes the first rejected NSSAI in a case that the UE transitions to the deregistered state for the current PLMN via certain access, in a case that the UE successfully registers with a new PLMN via certain access, in a case that the UE fails to register with a new PLMN via certain access and transitions to the deregistered state, or in a case that the UE is not registered (deregistered state) via other access. In other words, in a case that the UE transitions to a deregistered state with respect to the current PLMN via certain access and the UE is in a state of being registered (registered state) with the current PLMN via other access, the UE need not remove the first rejected NSSAI.

The S-NSSAI included in the first rejected NSSAI or the first rejected NSSAI may be referred to as S-NSSAI of the current PLMN. In other words, the S-NSSAI included in the first rejected NSSAI or the first rejected NSSAI may be stored and/or managed and/or transmitted and/or received only in association with the current PLMN ID or SNPN ID. Additionally or alternatively, the S-NSSAI included in the first rejected NSSAI may be S-NSSAI of the HPLMN, or may be an S-NSSAI of the current PLMN.

Second rejected NSSAI is a set of one or more pieces of the S-NSSAI that are not available in the current registration area. The second rejected NSSAI may be rejected NSSAI for the current registration area of the 5GS, mapped S-NSSAI(s) for rejected NSSAI for the current registration area, or S-NSSAI included in the mapped S-NSSAI(s) for rejected NSSAI for the current registration area. The list (set) of pieces of mapped S-NSSAI of the second rejected NSSAI may be one or more pieces of mapped S-NSSAI with respect to the second rejected NSSAI, or mapped S-NSSAI(s) for the rejected NSSAI for the current registration area of the 5GS. The second rejected NSSAI may be rejected NSSAI stored by the UE or the NW or may be rejected NSSAI transmitted from the NW to the UE. In a case that the second rejected NSSAI is rejected NSSAI transmitted from the NW to the UE, the second rejected NSSAI may be information including one or more combinations of S-NSSAI and a cause value. The rejection cause value at this time may be “S-NSSAI not available in the current registration area” or may be information indicating that the S-NSSAI associated with the cause value is not available in the current registration area. The S-NSSAI included in the second rejected NSSAI may be referred to as second rejected S-NSSAI.

In a case that the second rejected NSSAI is rejected NSSAI transmitted from the NW to the UE, one or more pieces of S-NSSAI rejected because they are unavailable in the current registration area among pieces of the S-NSSAI included in the requested NSSAI by the UE are included. In that case, the second rejected NSSAI may be included and transmitted and/or received in the rejected NSSAI IE or the Extended rejected NSSAI IE. The rejected NSSAI IE or the Extended rejected NSSAI IE may include at least one combination of the S-NSSAI of the current PLMN or SNPN and the rejection cause value. In a case that the UE is roaming, the foregoing combination may further include mapped S-NSSAI that is S-NSSAI of the HPLMN.

In other words, in the roaming case, the second rejected NSSAI transmitted from the NW to the UE may include at least one combination of the S-NSSAI of the current PLMN or SNPN, the mapped S-NSSAI, and the rejection cause value.

The second rejected NSSAI may be valid within the current registration area and may be applied to the current registration area. The UE and/or the NW may handle the second rejected NSSAI and the S-NSSAI included in the second rejected NSSAI as information for each access type. In other words, the second rejected NSSAI may be information valid for each of 3GPP access and non-3GPP access. In other words, once the UE transitions to the deregistered state with respect to certain access, the UE may remove the second rejected NSSAI associated with the access from the storage.

The S-NSSAI included in the second rejected NSSAI or the second rejected NSSAI may be referred to as S-NSSAI of the current PLMN. In other words, the S-NSSAI included in the second rejected NSSAI or the second rejected NSSAI may be stored and/or managed and/or transmitted and/or received only in association with the current PLMN ID or SNPN ID. Alternatively, the S-NSSAI included in the second rejected NSSAI may be S-NSSAI of the HPLMN, or may be an S-NSSAI of the current PLMN.

The third rejected NSSAI is S-NSSAI that requires NSSAA and is a set of one or more pieces of S-NSSAI for which the NSSAA for the S-NSSAI is failed or revoked. The third rejected NSSAI may be NSSAI stored in the UE and/or the NW or NSSAI transmitted and/or received between the NW and the UE. In a case that the third rejected NSSAI is transmitted from the NW to the UE, the third rejected NSSAI may be information including one or more combinations of S-NSSAI and a rejection cause value. The rejection cause value at this time may be “S-NSSAI not available due to the failed or revoked NSSAA” and may be information indicating that the NSSAA for the S-NSSAI associated with the rejection cause value has been failed or revoked. The S-NSSAI included in the third rejected NSSAI may be referred to as third rejected S-NSSAI.

In a case that the third rejected NSSAI is NSSAI transmitted from the NW to the UE, the third rejected NSSAI may be transmitted and/or received by using the rejected NSSAI IE or the Extended rejected NSSAI IE.

The third rejected NSSAI may be applied to a registered PLMN or a registered SNPN, may be applied to a registered PLMN and/or an EPLMN, or may be applied to a registered SNPN and/or an ESNPN, or may be applied to all PLMNs or SNPNs. The fact that the third rejected NSSAI is applied to all the PLMNs may mean that the third rejected NSSAI is not associated with the PLMNs or may mean that the third rejected NSSAI is associated with the HPLMN or the HSNPN.

Furthermore, the UE and/or the NW may handle the third rejected NSSAI and the third rejected S-NSSAI as information regardless of the access type. In other words, the third rejected NSSAI may be valid information for 3GPP access and non-3GPP access. The third rejected NSSAI may be NSSAI different from the rejected NSSAI. The third rejected NSSAI may be the first rejected NSSAI. The third rejected NSSAI may be rejected NSSAI for the failed or revoked NSSAA of the 5GS, or may be rejected S-NSSAI for the failed or revoked NSSAA, or may be S-NSSAI included in the rejected NSSAI for the failed or revoked NSSAA.

The third rejected NSSAI is rejected NSSAI allowing the UE to identify the slice that is rejected due to failure or revocation of NSSAA from the core network. Specifically, the UE does not initiate the registration request procedure for the S-NSSAI included in the third rejected NSSAI while storing the third rejected NSSAI. The third rejected NSSAI may be identification information including one or more pieces of S-NSSAI received from the core network in association with the rejection cause value indicating failure of NSSAA.

The third rejected NSSAI is information regardless of the access type. Specifically, in a case that the UE stores the third rejected NSSAI, the UE may not attempt to transmit, either on 3GPP access or on non-3GPP access, a registration request message including the S-NSSAI included in the third rejected NSSAI. Alternatively, the UE can transmit the registration request message including the S-NSSAI included in the third rejected NSSAI, based on a UE policy.

Alternatively, the UE may remove the third rejected NSSAI based on the UE policy and transition to a state in which the UE can transmit the registration request message including the S-NSSAI included in the third rejected NSSAI. In other words, in a case that the UE transmits, based on the UE policy, the registration request message including the S-NSSAI included in the third rejected NSSAI, the UE may remove the S-NSSAI from the third rejected NSSAI.

The S-NSSAI included in the third rejected NSSAI at the time of roaming may be referred to as S-NSSAI of the HPLMN. In other words, the third rejected NSSAI received by the UE from the VPLMN or the VSNPN may include the S-NSSAI of the HPLMN or the HSNPN.

In other words, the UE and/or each apparatus may store a “third rejected NSSAI” in which the S-NSSAI of the HPLMN or the HSNPN is configured. That is, even at the time of roaming, the “third rejected NSSAI” may be stored without being associated with mapped S-NSSAI.

The fourth rejected NSSAI is information including one or more pieces of S-NSSAI that have reached the maximum number of UEs for each network slice. The fourth rejected NSSAI may be NSSAI stored by the UE or the NW, or may be NSSAI transmitted from the NW to the UE.

The fourth rejected NSSAI may be a rejected NSSAI for the maximum number of UEs reached in the 5GS, may be rejected S-NSSAI for the maximum number of UEs reached, may be S-NSSAI included in the rejected NSSAI for the maximum number of UEs reached, may be mapped S-NSSAI(s) for the maximum number of UEs reached, or may be S-NSSAI included in the mapped S-NSSAI(s) for the maximum number of UEs reached. The list (set) of pieces of the mapped S-NSSAI of the fourth rejected NSSAI may be one or more pieces of mapped S-NSSAI with respect to the fourth rejected NSSAI, or may be mapped S-NSSAI(s) for the maximum number of UEs reached in the 5GS.

In a case that the fourth rejected NSSAI is transmitted from the NW to the UE, the fourth rejected NSSAI may be information including one or more pieces of information including at least one of S-NSSAI (SST and/or SD), mapped S-NSSAI (SST and/or SD) (if any), a rejection cause value, or a value of the back-off timer. The rejection cause value at this time may be “S-NSSAI having reached the maximum number of UEs for each network slice (S-NSSAI not available due to maximum number of UEs reached)” and may be information indicating that the maximum number of UEs that can give notification of or allow the S-NSSAI associated with the rejection cause value as Allowed NSSAI has been reached.

The fifth rejected NSSAI may be rejected NSSAI different from the first to fourth pieces of rejected NSSAI. The fifth rejected NSSAI may be rejected NSSAI referred to for a temporary network slice. For example, the fifth rejected NSSAI may be rejected NSSAI for the temporary network slice.

Here, the rejection cause value may be a rejection cause value included in the rejected NSSAI. Furthermore, at this time, the value of the back-off timer may be information indicating a time period during which the UE is prohibited from transmitting an MM message using the one or more pieces of S-NSSAI associated with the value of the back-off timer and/or the S-NSSAI of the current PLMN or SNPN associated with one or more pieces of mapped S-NSSAI.

The fourth rejected NSSAI may be applied to the registered PLMN and/or EPLMN, may be applied to the registered SNPN and/or ESNPN, or may be applied to one or more PLMNs or SNPNs to which TAIs included in a TA list (a TAI list or a registration area) belong.

The UE and/or the NW may handle the fourth rejected NSSAI and the S-NSSAI included in the fourth rejected NSSAI as information for each access type.

In a case that the fourth rejected NSSAI is NSSAI transmitted from the NW to the UE, the fourth rejected NSSAI may be transmitted and/or received by using the rejected NSSAI IE or the Extended rejected NSSAI IE.

In a case that the first to fourth pieces of rejected NSSAI are transmitted and/or received using the rejected NSSAI IE or the Extended rejected NSSAI IE, the rejected NSSAI IE and the Extended rejected NSSAI IE may include a list of pieces of rejected S-NSSAI.

In a case that the first to fourth pieces of rejected NSSAI are transmitted and/or received using the rejected NSSAI IE, the list of pieces of the rejected S-NSSAI included in the rejected NSSAI IE may be one or more pieces of Rejected S-NSSAI of the 5GS. In the Rejected S-NSSAI, the S-NSSAI (SST and/or SD) of the current PLMN or SNPN and a corresponding rejection cause value may be configured.

In a case that the first to fourth pieces of rejected NSSAI are transmitted and/or received using the Extended rejected NSSAI IE, the list of pieces of the rejected S-NSSAI included in the Extended rejected NSSAI IE may be a Partial extended rejected NSSAI list of the 5GS.

The list of pieces of the rejected S-NSSAI includes a list of a first type not including the value of the back-off timer and a list of a second type including the value of the back-off timer applied to all pieces of the S-NSSAI included in the list of pieces of the rejected S-NSSAI. In the Extended rejected NSSAI IE, one or more lists of the first type and/or one or more second lists may be configured.

In the list of the first type, information indicating that the list is of the first type and one or more pieces of Rejected S-NSSAI of one or more 5GSs may be configured. In the Rejected S-NSSAI, the S-NSSAI (SST and/or SD) of the current PLMN or SNPN and a corresponding rejection cause value may be configured. In addition, in the Rejected S-NSSAI, the mapped S-NSSAI (SST and/or SD) may be configured.

The information indicating that the list is of the first type may mean that the list includes one or more pieces of S-NSSAI not together with the value of a corresponding back-off timer. In other words, it may mean that the list does not include the value of the back-off timer corresponding to one or more pieces of S-NSSAI included in the list.

In the list of the second type, information indicating that the list is of the second type, the back-off timer value, and one or more pieces of Rejected S-NSSAI of the 5GS may be configured. In the Rejected S-NSSAI, the S-NSSAI (SST and/or SD) of the current PLMN or SNPN and a corresponding rejection cause value may be configured. In addition, in the Rejected S-NSSAI, the mapped S-NSSAI (SST and/or SD) may be configured.

The information indicating that the list is of the second type may be information meaning that the list includes one or more pieces of S-NSSAI and the value of the back-off timer corresponding thereto and that the value of the back-off timer is adapted to all pieces of the S-NSSAI.

Note that the value of the back-off timer included in the list of the second type may be the value applied to all pieces of the S-NSSAI included in the same list of the second type.

The pending NSSAI may be pending NSSAI of the 5GS. The pending NSSAI may be NSSAI stored in the UE and/or the NW or may be NSSAI transmitted and/or received between the NW and the UE.

In a case that the pending NSSAI is NSSAI to be transmitted from the NW to the UE, the pending NSSAI may be transmitted and/or received using pending NSSAI IEs including one or more S-NSSAI IEs. The S-NSSAI IEs may include S-NSSAI (SST and/or SD) and the mapped S-NSSAI (SST of the mapped HPLMN or HSNPN and/or SD of the mapped HPLMN or HSNPN) (if any, for example, in a case that the UE performs roaming or in a case that associated PLMN or SNPN is a VPLMN or a VSNPN).

The pending NSSAI may be applied to all registered PLMNs or registered SNPNs, may be applied to the registered PLMNs and one or more EPLMNs of the registered PLMNs, or may be applied to the registered SNPNs and one or more ESNPN of the registered SNPNs.

The UE and/or the NW may handle the S-NSSAI included in the pending NSSAI as information regardless of the access type. In other words, the pending NSSAI may be information in common to 3GPP access and non-3GPP access.

The pending NSSAI is NSSAI including one or more pieces of S-NSSAI identifying slices for which the UE is pending the procedure. Specifically, while storing the pending NSSAI, the UE does not initiate the registration request procedure for the S-NSSAI included in the pending NSSAI or mapped S-NSSAI of the pending NSSAI.

In other words, the UE does not use the S-NSSAI included in the stored pending NSSAI during the registration procedure until NSSAA for the S-NSSAI included in the pending NSSAI is completed. The pending NSSAI is information regardless of the access type. Specifically, in a case that the UE stores the pending NSSAI, the UE does not attempt to transmit, either on 3GPP access or on non-3GPP access, a registration request message including the S-NSSAI included in the pending NSSAI.

During roaming (roaming scenario), the S-NSSAI included in the pending NSSAI stored in the UE may be the S-NSSAI of the HPLMN or the HSNPN. In other words, the pending NSSAI IE received by the UE from the VPLMN or VSNPN may include the S-NSSAI of the HPLMN or the SNPN. The pending NSSAI may be referred to as first pending NSSAI.

In other words, the UE storing the first pending NSSAI intends not to store the mapped S-NSSAI for the first pending NSSAI, and the S-NSSAI configured for the first pending NSSAI stored in the UE is the S-NSSAI of the HPLMN or the HSNPN, regardless of roaming or non-roaming being performed.

Note that, in a case that the first pending NSSAI is transmitted from the NW to the UE, that is, the UE receives the pending NSSAI from the NW, the pending NSSAI IE including the pending NSSAI may include the mapped S-NSSAI of the current S-NSSAI, or may include only the mapped S-NSSAI.

On the other hand, during roaming (roaming scenario), the S-NSSAI included in the pending NSSAI stored in the UE may be the S-NSSAI of the current PLMN (VPLMN) or SNPN (VSNPN). In other words, the pending NSSAI received by the UE from the VPLMN or VSNPN may include the S-NSSAI of the VPLMN or VSNPN. Such pending NSSAI may be referred to as second pending NSSAI.

In other words, at the time of roaming, there may be one or more pieces of mapped S-NSSAI with respect to the second pending NSSAI. The S-NSSAI included in the second pending NSSAI may be the S-NSSAI of the current PLMN or SNPN, regardless of roaming or non-roaming being performed.

In the present document, the term “pending NSSAI” may mean the first pending NSSAI, may mean the second pending NSSAI, may mean both pieces of the pending NSSAI, or may mean other pending NSSAI.

A tracking area is a single or multiple ranges that can be expressed using location information of the UE_A 10 managed by the core network. The tracking area may include multiple cells. Furthermore, the tracking area may be a range in which a control message such as paging is broadcast, or may be a range in which the UE_A 10 can move without performing a handover procedure. Furthermore, the tracking area may be a routing area, may be a location area, or may be any area similar to these. The tracking area may be hereinafter a TA. The tracking area may be identified by a Tracking Area Identity (TAI) including a Tracking area code (TAC) and a PLMN.

The Registration area is a set of one or more TAs allocated to the UE by the AMF. Note that, while moving within one or more TAs included in a registration area, the UE_A 10 may be able to move without transmitting and/or receiving a signal for updating the tracking area. In other words, the registration area may be an information group indicating an area in which the UE_A 10 can move without performing a tracking area update procedure. The registration area may be identified with a TAI list including one or more TAIs.

A TAI included in the TAI list may belong to one PLMN or multiple PLMNs. In a case that multiple TAIs included in the TAI list belong to different PLMNs, the PLMNs may be EPLMNs.

A UE ID is information for identifying the UE. Specifically, the UE ID may be a Subscription Concealed Identifier (SUCI), or a Subscription Permanent Identifier (SUPI), or a Globally Unique Temporary Identifier (GUTI), or an International Mobile Subscriber Identity (IMEI), or an IMEI Software Version (IMEISV), or a Temporary Mobile Subscriber Identity (TMSI), for example. Alternatively, the UE ID may be other information configured by an application or within the network. Moreover, the UE ID may be information for identifying the user.

Management of the maximum number of UEs connected to a slice is to manage and/or control the maximum number of UEs that can be registered with the network slice or S-NSSAI simultaneously, or management and/or control of the maximum number of UEs that can establish a PDU session using the network slice or S-NSSAI simultaneously. Management of the maximum number of UEs connected to a slice may be network slice admission control (NSAC) in the 5GS. NSAC may be expressed as slice admission control.

Management and/or control of the maximum number of UEs that can be simultaneously registered in a network slice or an S-NSSAI may be referred to as MM based slice admission control (Mobility management based slice admission control). Management and/or control of the maximum number of UEs that can establish a PDU session using a network slice or S-NSSAI simultaneously may be referred to as Session management (SM) based slice admission control. The slice admission control may mean Network Slice Admission Control (NSAC).

Here, the UE registered with the network slice or the S-NSSAI may refer to the S-NSSAI indicating the network slice included in allowed NSSAI for storage. An apparatus within a network, the apparatus supporting the function to manage the maximum number of UEs connected to a slice or the function to manage and/or control the maximum number of UEs that can be registered with a network slice or S-NSSAI simultaneously can store, for each piece of S-NSSAI, whether to require management of the maximum number of UEs connected to the slice and can further check, during the registration procedure, whether the number of registered UEs has reached a certain constant corresponding to the maximum number.

Furthermore, each apparatus supporting the function to manage the maximum number of UEs connected to a slice or the function to manage and/or control the maximum number of UEs that can be registered with the network slice or S-NSSAI simultaneously is good to be able to store the fourth rejected NSSAI. In the present document, the maximum number of UEs connected to a slice may be referred to as a maximum number of UEs connected for each slice, or a maximum number of UEs that can be registered with the network slice or the S-NSSAI, or a maximum number of UEs, or a fixed value.

Session and Service Continuity (SSC) is a technique for maintaining a session and/or a service. Here, the session may mean a PDU session established between the UE and the NW, and the service may mean a service provided to the UE owing to the PDU session established between the UE and the NW. There may be various modes.

In other words, the Session and Service Continuity (SSC) mode indicates a mode of Session and Service Continuity supported by a system and/or each apparatus in the 5GC. More specifically, the SSC mode may be a mode indicating a type of session and service continuity supported by a PDU session established between the UE_A 10 and an anchor point.

Here, the anchor point may be the UPGW, or may be the UPF. The UPF may be a terminating user-plane function (TUPF). The TUPF is a terminating UPF of each interface, and includes a PDU session anchor function. In other words, the anchor point may be a PDU Session Anchor.

To switch the anchor point for SSC may be referred to as anchor relocation and/or PDU session anchor change. Note that these may be referred to as an anchor relocation procedure or a PDU session anchor change procedure. The anchor relocation may be a concept including the PDU session anchor change without change of the network slice and/or the S-NSSAI, or may be a concept including the PDU session anchor change with change of the network slice and/or the S-NSSAI.

In anchor relocation, the PDU session established in the initial state may be referred to as a first PDU session, and the PDU session established after completion of the procedure may be referred to as a second PDU session.

Note that the SSC mode may be a mode indicating a type of session and service continuity configured for each PDU session. In other words, the SSC mode may be associated with a PDU session.

Additionally/alternatively, the SSC mode may be associated with the anchor point, and may be controlled so that the SSC mode cannot be changed during a state in which the PDU session is established. During life time of the PDU session, the SSC mode associated with the PDU session may not be able to be changed. Each SSC mode will be described below.

SSC mode 1 is a mode of the session and service continuity in which the same UPF is continuously maintained as the anchor point regardless of access technology such as Radio Access Technology (RAT) and the cell used by the UE_A 10 to connect to the network. More specifically, the SSC mode 1 may be a mode in which even in a case that the mobility of the UE_A 10 occurs, the session and service continuity is achieved without changing the anchor point used by the established PDU session.

SSC mode 2 is a mode of the session and service continuity in which, in a case that one anchor point is included in a PDU session, the PDU session is first released and subsequently a PDU session is established. More specifically, the SSC mode 2 is a mode in which, in a case that relocation of the anchor point occurs, a PDU session is once removed and then a new PDU session is established.

The SSC mode 2 is a mode of the session and service continuity in which the same UPF is continuously maintained as the anchor point only in a serving area of the UPF. More specifically, SSC mode 2 may be a mode in which session and service continuity is implemented without changing the UPF that is used in an established PDU session, on the condition that the UE_A 10 is present within the serving area of the UPF. In addition, SSC mode 2 may be a mode in which session and service continuity is implemented with the UPF that is used in an established PDU session being changed, in a case that there is occurrence of such mobility of the UE_A 10 that the UE_A 10 exits the serving area of the UPF.

Here, the serving area of the UPF may refer to an area in which one UPF can provide a session and service continuity function, or may be a subset of RATs and access networks such as cells used in a case that the UE_A 10 connects to the network. In addition, the subset of the access network may be a network including one or more RATs and/or cells, or may be the TA.

In session continuity in the SSC mode 2, in a case that change of the S-NSSAI is not allowed, it may be referred to as first SSC mode 2. On the other hand, in session continuity in the SSC mode 2, in a case that change of the S-NSSAI is allowed, it may be referred to as second SSC mode 2. In other words, a case that session continuity is performed in the SSC mode 2 with the S-NSSAI or the network slice being changed may be referred to as the second SSC mode 2.In yet other words, a case that the PDU session of the SSC mode 2 is continued with the S-NSSAI or the network slice being changed may be referred to as the second SSC mode 2. The term “SSC mode 2” by itself may mean the first SSC mode 2 and/or the second SSC mode 2.

SSC mode 3 is a mode of the session and service continuity in which, without releasing a PDU session between the UE and the anchor point, a PDU session can be established between a new anchor point and the UE for the same DN.

The SSC mode 3 is a mode of the session and service continuity that allows establishment of a new PDU session and/or communication path via a new UPF for the same DN before disconnecting a PDU session and/or a communication path that has been established between the UE_A 10 and the UPF. In addition, the SSC mode 3 may be a mode of the session and service continuity that allows the UE_A 10 to be multihomed.

Additionally/alternatively, the SSC mode 3 may be a mode that allows the session and service continuity using multiple PDU sessions and/or the UPFs associated with the PDU sessions. In other words, in a case of the SSC mode 3, each apparatus may implement the session and service continuity using multiple PDU sessions, or may implement the session and service continuity using multiple UPFs.

In session continuity in the SSC mode 3, in a case that change of the S-NSSAI is not allowed, it may be referred to as first SSC mode 3. On the other hand, in session continuity in the SSC mode 3, in a case that change of the S-NSSAI is allowed, it may be referred to as second SSC mode 3. In other words, a case that session continuity is performed in the SSC mode 3 with the S-NSSAI or the network slice being changed may be referred to as the second SSC mode 3.In yet other words, a case that the PDU session of the SSC mode 3 is continued with the S-NSSAI or the network slice being changed may be referred to as the second SSC mode 3. The term “SSC mode 3” by itself may mean the first SSC mode 3 and/or the second SSC mode 3.

SSC mode 4 may be the second SSC mode 2.

In other words, SSC mode 4 is a mode of the session and service continuity in which, in a case that one anchor point is included in a PDU session, the PDU session is first released and subsequently a PDU session is established with the S-NSSAI or the network slice being changed. More specifically, the SSC mode 4 is a mode in which, in a case that relocation of the anchor point occurs, a PDU session is once removed and then a new PDU session is established with the S-NSSAI or the network slice being changed.

The SSC mode 4 is a mode of the session and service continuity in which the same UPF is continuously maintained as the anchor point with the S-NSSAI or the network slice being changed only in a serving area of the UPF. More specifically, SSC mode 4 may be a mode in which session and service continuity is implemented without changing the UPF that is used in an established PDU session with the S-NSSAI or the network slice being changed, on the condition that the UE_A 10 is present within the serving area of the UPF. In addition, SSC mode 4 may be a mode in which session and service continuity is implemented with the UPF that is used in an established PDU session being changed and with the S-NSSAI or the network slice being changed, in a case that there is occurrence of such mobility of the UE_A 10 that the UE_A 10 exits the serving area of the UPF.

Here, the serving area of the UPF may refer to an area in which one UPF can provide a session and service continuity function, or may be a subset of RATs and access networks such as cells used in a case that the UE_A 10 connects to the network. In addition, the subset of the access network may be a network including one or more RATs and/or cells, or may be the TA.

SSC mode 5 may be the second SSC mode 3.

In other words, the SSC mode 5 is a mode of the session and service continuity in which, without releasing a PDU session between the UE and the anchor point, a PDU session can be established between a new anchor point and the UE for the same DN, with the S-NSSAI or the network slice being changed.

The SSC mode 5 is a mode of the session and service continuity that allows establishment of a new PDU session and/or communication path via a new UPF for the same DN before disconnecting a PDU session and/or a communication path that has been established between the UE_A 10 and the UPF with the S-NSSAI or the network slice being changed. In addition, the SSC mode 5 may be a mode of the session and service continuity that allows the UE_A 10 to be multihomed.

The SSC mode 5 may be a mode that allows the session and service continuity using multiple PDU sessions and/or the UPFs associated with the PDU sessions. In other words, in a case of the SSC mode 5, each apparatus may implement the session and service continuity using multiple PDU sessions, or may implement the session and service continuity using multiple UPFs.

Subscription information may also include restrictions to simultaneous registration of network slices. The subscription information is provided to a serving AMF (AMF serving the UE, AMF to which the UE is connected) as a UE subscription in the form of Network Slice Simultaneous Registration Group (NSSRG) information. The subscription information may include, for each piece of S-NSSAI, a subscribed DNN list and one default DNN, and/or information indicating whether the S-NSSAI is marked as default subscribed S-NSSAI, and/or information indicating whether the S-NSSAI is associated with the NSSAA, and/or the NSSRG information. The subscription information may be information that the UDM transmits to the AMF. In other words, the UDM may be information that manages subscription information.

The subscription information for the UE may include the NSSRG information for each piece of S-NSSAI. The NSSRG information may be information for restricting which S-NSSAI in the Allowed NSSAI can be simultaneously provided to the UE. In a case that multiple pieces of S-NSSAI have associated NSSRG information, one or more pieces of S-NSSAI included in the allowed NSSAI may share at least one (common) NSSRG. In a case that the NSSRG information is present in the subscription information, each piece of S-NSSAI included in the subscription information may be associated with at least one NSSRG. In a case that the AMF receives the subscription information for the UE that includes the NSSRG information, the Allowed NSSAI for that UE may include only one or more pieces of S-NSSAI such as those having the common NSSRG. The subscription information including the NSSRG information may include at least one piece of default S-NSSAI. In a case of receiving requested NSSAI from the UE, the AMF supporting a processing function for the NSSRG and/or the NSSRG information may determine whether to be able to provide the S-NSSAI of the HPLMN together to the allowed NSSAI based on the NSSRG information for the S-NSSAI of the HPLMN.

The UE may include information indicating whether to support these functions (functions of subscription-based restrictions to simultaneous registration of network slices feature) in the 5GMM capability IE included in the registration request message for transmission. In other words, the information indicating whether the UE supports the functions of subscription-based restrictions to simultaneous registration of network slices feature may be included as 41st identification information. The NW may include the information indicating whether to support these functions (functions of subscription-based restrictions to simultaneous registration of network slices feature) in a 5GS network feature support IE included in the registration accept message or the registration reject message for transmission. In other words, the information indicating whether the NW supports the functions of subscription-based restrictions to simultaneous registration of network slices feature may be included as 51st identification information.

In a case that the serving AMF provides the configured NSSAI to the UE, in a case that the serving AMF indicates that the UE supports the functions of subscription-based restriction to simultaneous registration of network slices feature, the AMF may provide the NSSRG information related to the S-NSSAI of the HPLMN present in the mapping information of the configured NSSAI to the UE. The UE that receives the NSSRG information may include the S-NSSAI having the common NSSRG in the requested NSSAI.

First identification information may be information indicating network slices. The first identification information may be information indicating network slices requested by the UE. The first identification information may be requested NSSAI.

Second identification information may be information indicating UE capability. The second identification information may be information indicated as 5GMM capability, or may be information included in 5GMM capability. The second identification information may be information indicating whether or not the UE supports temporary network slices. The second identification information may be information indicating that the UE supports temporary network slices. The second identification information may be information indicating that the UE does not support temporary network slices. The second identification information may be information indicating whether or not the UE includes capability of processing timing information related to network slices. The second identification information may be information indicating that the UE includes capability of processing timing information related to network slices. The second identification information may be information indicating that the UE does not include capability of processing timing information related to network slices. The second identification information may be information indicating whether or not the UE includes capability of processing information related to a time or a time period in which network slices are available. The second identification information may be information indicating that the UE includes capability of processing information related to a time or a time period in which network slices are available. The second identification information may be information indicating that the UE does not include capability of processing information related to a time or a time period in which network slices are available.

Third identification information may be information indicating a type of requested registration. The third identification information may be information indicated as a 5GS registration type, or may be information included in a 5GS registration type and/or a 5GS registration type. The third identification information may indicate initial registration, mobility registration updating, periodic registration updating, emergency registration, SNPN onboarding registration, roaming mobility registration updating, or disaster roaming initial registration.

Fourth identification information may be information indicating request for update of timing information. The fourth identification information may be information indicating request for transmission of updated timing information.

Fifth identification information is information including at least one piece of identification information out of the first identification information to the fourth identification information.

Note that transmission and/or reception of at least one piece of identification information out of the first identification information to the fourth identification information may mean transmission and/or reception of the fifth identification information.

11th identification information may be information related to network slices. The 11th identification information may be information indicating network slices transmitted from the network. The 11th identification information may be one or more pieces of NSSAI. The 11th identification information may be one or more pieces of S-NSSAI indicating temporary network slices. Specifically, the 11th identification information may be the allowed NSSAI, and/or the configured NSSAI, and/or the rejected NSSAI, and/or the Extended rejected NSSAI, and/or the pending NSSAI transmitted from the network to the UE. In other words, the 11th identification information may be the allowed NSSAI, and/or the configured NSSAI, and/or the rejected NSSAI, and/or the Extended rejected NSSAI, and/or the pending NSSAI including one or more pieces of S-NSSAI indicating temporary network slices. The 11th identification information may include 13th identification information and/or 14th identification information.

12th identification information may be information indicating network capability (NW capability). The 12th identification information may be information indicated as 5GS network feature support, or may be information included in 5GS network feature support. The 12th identification information may be information indicating whether or not the network supports temporary network slices. The 12th identification information may be information indicating that the network supports temporary network slices. The 12th identification information may be information indicating that the network does not support temporary network slices. The 12th identification information may be information indicating whether or not the network includes capability of processing timing information related to network slices. The 12th identification information may be information indicating that the network includes capability of processing timing information related to network slices. The 12th identification information may be information indicating that the network does not include capability of processing timing information related to network slices. The 12th identification information may be information indicating whether or not the network includes capability of processing information related to a time or a time period in which network slices are available. The 12th identification information may be information indicating that the network includes capability of processing information related to a time or a time period in which network slices are available. The 12th identification information may be information indicating that the network does not include capability of processing information related to a time or a time period in which network slices are available.

The 13th identification information may be a timer value. The 13th identification information may be information related to a time period in which network slices are available (which may also be referred to as a time at which network slices are available, network slices being available, or timing information related to network slices). The 13th identification information may be a value in common to all of the UEs, may be a common value for each UE group, or may be a value different for each UE. The 13th identification information may be information included in the 11th identification information. The 13th identification information may be a timer value corresponding to the 11th identification information.

The 14th identification information may be information indicating whether or not configuration information is enabled. For example, the 14th identification information may be information indicating whether or not the 11th identification information and/or the 13th identification information is enabled. In other words, the 14th identification information may be information corresponding to the 11th identification information and/or the 13th identification information. The 14th identification information may be information included in the 11th identification information and/or the 13th identification information.

The 15th identification information may be a cause value indicating rejection of the request of the UE. The 15th identification information may be a 5GMM cause or a 5GSM cause. The 15th identification information may indicate that network slices are unavailable, may indicate that the network slices are unavailable because of being temporary network slices, may indicate that the network slices are permanently unavailable because of being temporary network slices, may indicate the network slices are unavailable because the network slices have become disabled, may indicate the network slices are unavailable because the network slices are no longer enabled, may indicate the network slices are unavailable because a time or a time period in which the network slices are available has passed, may indicate the network slices are unavailable because a time or a time period in which the network slices are available has passed and the network slices have become disabled, or may indicate the network slices are unavailable because a time or a time period in which the network slices are available has passed and the network slices are no longer enabled. The 15th identification information may indicate that there are no available network slices, or network slices are not available, or network slices are not enabled, or network slices are disabled, or network slices have timed out.

The 16th identification information is information including at least one piece of identification information out of the 11th identification information to the 15th identification information.

Note that transmission and/or reception of at least one piece of identification information out of the 11th identification information to the 15th identification information may mean transmission and/or reception of the 16th identification information.

### 3. Description of Procedures Used in Each Embodiment

Next, procedures used in each embodiment will be described. Note that the procedures used in each embodiment include the MM procedure and the SM procedure, which include the registration procedure, and/or the configuration update procedure, and/or the de-registration procedure, and/or the PDU session release procedure, and/or the like. Each procedure will be described below.

Note that, in each embodiment, a case that each of the HSS and the UDM, the PCF and the PCRF, the SMF and the PGW-C, and the UPF and the PGW-U is configured as a single apparatus (that is, the same physical hardware, or the same logical hardware, or the same software) as illustrated in FIG. 2 will be described as an example. However, the details described in the present embodiment can also be applied to a case that each of the combinations is configured as different apparatuses (that is, different pieces of physical hardware, or different pieces of logical hardware, or different pieces of software). For example, between the apparatuses/functions, data may be directly transmitted and/or received, data may be transmitted and/or received via an N26 interface between the AMF and the MME, or data may be transmitted and/or received via the UE.

### 3.1. Registration Procedure

Now, the Registration procedure will be described with reference to FIG. 11. In this section, the registration procedure may be simply referred to as the present procedure. The registration procedure is a procedure for registration with the access network_B, and/or the core network_B, and/or the DN initiated by the UE. In a case that the UE is in a state of not being registered with the network, for example, the UE can perform the present procedure at any timing, for example, a power input time. In other words, the UE can initiate the present procedure at any timing as long as the UE is in the deregistered state (5GMM-DEREGISTERED state). In addition, each apparatus (in particular, the UE and the AMF) can transition to the registered state (5GMM-REGISTEDED state), based on completion of the registration procedure. Note that each registered state may be managed by each apparatus for each access. Specifically, each apparatus may independently manage the registration state (registered state or deregistered state) for 3GPP access and the registration state for non- 3GPP access.

In addition, the registration procedure may be a procedure for updating position registration information of the UE on the network, and/or periodically provide notification of the state of the UE from the UE to the network, and/or updating a specific parameter related to the UE on the network.

The UE may initiate the registration procedure in a case of moving to a TA outside the current registration area. In other words, the UE may initiate a registration procedure in a case that the UE has moved to a TA different from TAs indicated in a stored TA list. In addition, the UE may initiate the registration procedure in a case that a context of each apparatus needs to be updated due to disconnection and deactivation of a PDU session. In addition, in a case that there is a change in capability information and/or a preference, related to PDU session establishment, of the UE, the UE may initiate the registration procedure. In addition, the UE may periodically initiate the registration procedure. Further, the UE may initiate the registration procedure, based on completion of the registration procedure, completion of the PDU session establishment procedure, or information received from the network in each procedure. The UE may initiate the present procedure after performing the procedures in Section 3 one or more times. Note that the UE is not limited to this configuration, and can perform the registration procedure at any timing.

The present procedure may be performed in the PLMN (HPLMN or VPLMN), or the equivalent PLMN, or the SNPN, or the equivalent SNPN, or the ON-SNPN, or the SO-SNPN.

Note that the above-described procedure for the UE to transition from the state (deregistered state) of not being registered with the network to the state (registered state) of being registered with the network may be an initial registration procedure or a registration procedure for initial registration. The registration procedure performed in the state (registered state) in which the UE is registered with the network may be a registration procedure for mobility and periodic registration update or a mobility and periodic registration procedure.

Note that the UE may or may not store each piece of NSSAI and/or S-NSSAI included in each piece of NSSAI described in Section 2.6 at the time of initiating the present procedure. The UE may initiate the present procedure in a case that the UE has stored each piece of NSSAI and/or S-NSSAI included in each piece of NSSAI described in Section 2.6 at the time of initiating the present procedure. The UE may perform one or more of the present procedures after storing each piece of NSSAI and/or S-NSSAI included in each piece of NSSAI acquired from the network by performing the present procedure.

The details of the registration procedure described below are applicable to any of the pieces of NSSAI described above.

First, the UE initiates the registration procedure by transmitting, to the AMF, a NAS message including the Registration request message (S600)(S602)(S604). Specifically, the UE transmits, to the base station apparatus (also referred to as the 5G AN or the gNB), an RRC message including a NAS message including the registration request message (S600). Moreover, the registration request message is a NAS message transmitted and/or received over the N1 interface. In addition, the RRC message may be a control message transmitted and/or received between the UE and the base station apparatus. In addition, the NAS message is processed in the NAS layer, and the RRC message is processed in the RRC layer. Note that the NAS layer is a layer higher than the RRC layer.

Here, the UE may include at least one piece of identification information out of the first identification information to the fifth identification information in the registration request message and/or the RRC message for transmission. Here, the first identification information to the fifth identification information may be as described in Section 2.6.

The UE may include these pieces of identification information in a control message different from the above, for example, a control message of a layer (for example, a Medium Access Control (MAC) layer, a Radio Link Control (RLC) layer, a Packet Data Convergence Protocol (PDCP) layer, a Service Data Adaptation Protocol (SDAP) layer, or the like) lower than the RRC layer, and transmit them. Note that, by transmitting these pieces of identification information, the UE may indicate that the UE supports the functions, or may indicate a request from the UE, or may indicate information indicated by each piece of identification information to the network.

Note that the UE may select or determine whether to transmit at least one piece of identification information out of the first identification information to the fifth identification information to the network, based on the UE capability information, and/or the UE policy, and/or the UE state, and/or the user registration information, and/or a context stored in the UE, and/or the identification information transmitted and/or received in a procedure performed before the present procedure, and/or the like.

In a case that the UE supports temporary network slices, or the UE includes capability of processing timing information related to network slices, or the UE includes capability of processing information related to a time or a time period in which network slices are available, the UE may set the second identification information to indicate that the UE supports the temporary network slices, or the UE includes the capability of processing timing information related to the network slices, or the UE includes the capability of processing information related to a time or a time period in which the network slices are available, and transmit the second identification information.

In a case that the UE does not support temporary network slices, or the UE does not include capability of processing timing information related to network slices, or the UE does not include capability of processing information related to a time or a time period in which network slices are available, the UE may set the second identification information to indicate that the UE does not support the temporary network slices, or the UE does not include the capability of processing timing information related to the network slices, or the UE does not include the capability of processing information related to a time or a time period in which the network slices are available, and transmit the second identification information.

In a case that the UE does not support temporary network slices, or the UE does not include capability of processing timing information related to network slices, or the UE does not include capability of processing information related to a time or a time period in which network slices are available, the UE need not transmit the second identification information related to whether or not the UE supports the temporary network slices, or whether or not the UE includes the capability of processing timing information related to the network slices, or whether or not the UE includes the capability of processing information related to a time or a time period in which the network slices are available.

In a case that the UE requests update of timing information or requests transmission of updated timing information, the UE may set the fourth identification information to indicate request for update of the timing information or indicate request for transmission of the updated timing information, and transmit the fourth identification information.

In addition, in a case that multiple pieces of identification information are transmitted and/or received, two or more pieces of identification information of these pieces of identification information may be configured as one or more pieces of identification information. Note that information indicating support of each function and information indicating a request for use of each function may be transmitted and/or received as the same piece of identification information, or may be transmitted and/or received as different pieces of identification information.

Next, in a case of receiving an RRC message including a NAS message including the registration request message, the base station apparatus selects the AMF to transfer the received RRC message, and/or registration request message, and/or NAS message (S602), and transfers those to the selected AMF (S604). Note that the base station apparatus may select the AMF, based on the identification information included in the registration request message and/or the NAS message and/or the RRC message. Specifically, in a case of receiving at least one piece of identification information out of the first identification information to the fifth identification information, the base station apparatus may select the AMF, based on the received identification information. For example, the base station apparatus may select the AMF included in the network slices identified by the first identification information, or may select the AMF having connectivity to network slices identified by the first identification information. The base station apparatus may select the AMF including the NW function corresponding to UE capability information indicated by the second identification information. Note that the method of selecting the AMF is not limited to the methods described above, and the base station apparatus may select the AMF based on other conditions.

Next, in a case of receiving the registration request message or the like from the base station apparatus, the AMF can perform first condition fulfillment determination. The first condition fulfillment determination is a decision as to whether the network is to accept the request of the UE. In a case of determining that the first condition fulfillment determination is true, the AMF may perform the procedure from S610 to S612. In a case that the first condition fulfillment determination is false, the AMF may perform the procedure in S610.

A network function (also referred to as an NF) other than the AMF may perform the first condition fulfillment determination. In a case that an NF other than the AMF performs the first condition fulfillment determination, the AMF may provide the NF with information necessary for performing the first condition fulfillment determination, specifically, at least a part of the information received from the UE (S606). Then, in a case that the NF determines true or false of the first condition fulfillment determination based on the information received from the AMF, the NF may notify the AMF of information including results (in other words, true or false) of the first condition fulfillment determination. The AMF may determine the identification information and/or the control message to be transmitted to the UE, based on the results of the first condition fulfillment determination received from the NF.

Note that, in a case that the first condition fulfillment determination is true, the control message transmitted and/or received in S610 may be a Registration accept message, and in a case that the first condition fulfillment determination is false, the control message transmitted and/or received in S610 may be a registration accept message or a Registration reject message except for a special case. Note that the control message may be transmitted in a NAS message. The NAS message may be transmitted in an RRC message.

Note that the first condition fulfillment determination may be performed based on reception of the registration request message or the like received from the base station apparatus, and/or each piece of identification information included in the registration request message or the like, and/or subscriber information, and/or capability information of the network, and/or the operator policy, and/or a state of the network, and/or registration information of the user, and/or a context stored in the AMF, and/or the like.

For example, in a case that the network allows or does not reject the request of the UE, the first condition fulfillment determination may be true, whereas in a case that the network does not allow or rejects the request of the UE, the first condition fulfillment determination may be false. In a case that the network allows or does not reject a part of the request from the UE, the first condition fulfillment determination may be true even in a case that the network does not allow a certain part of the request from the UE. In a case that the network allows none of the request from the UE or rejects all of the request from the UE, the first condition fulfillment determination may be false. In a case that a network with which the UE is to be registered and/or an apparatus in the network supports the function requested by the UE, the first condition fulfillment determination may be true, whereas in a case that the network and/or the apparatus does not support the function requested by the UE, the first condition fulfillment determination may be false. Further, in a case that the received identification information is allowed, the first condition fulfillment determination may be true, whereas in a case that the received identification information is not allowed, the first condition fulfillment determination may be false.

The AMF may include at least one piece of identification information out of the 11th identification information to the 16th identification information in the control message, and transmit the control message to the UE via the base station apparatus. Here, the 11th identification information to the 16th identification information may be as described in Section 2.6. Note that, by transmitting these pieces of identification information and/or the control message, the AMF may indicate whether the network supports the functions, may indicate whether the request from the UE is accepted, or may indicate information of a combination of these. In addition, in a case that multiple pieces of identification information are transmitted and/or received, two or more pieces of identification information of these pieces of identification information may be configured as one or more pieces of identification information. Note that the information indicating support of the functions and the information indicating allowing of use of the functions may be transmitted and/or received as the same piece of identification information, or may be transmitted and/or received as different pieces of identification information.

In a case of receiving at least one piece of identification information out of the first identification information to the fifth identification information from the UE, the AMF may transmit the control message including at least one piece of identification information out of the 11th identification information to the 16th identification information. Even in a case of receiving the registration request message or the like not including at least one piece of identification information out of the first identification information to the fifth identification information from the UE, the AMF may transmit the control message including at least one piece of identification information out of the 11th identification information to the 16th identification information.

Note that the AMF may determine whether to include at least one piece of identification information out of the 11th identification information to the 16th identification information in the control message, based on each piece of received identification information, and/or subscriber information, and/or capability information of the network, and/or the operator policy, and/or the state of the network, and/or registration information of the user, and/or the context stored in the AMF, and/or identification information transmitted and/or received in a procedure performed before the present procedure, and/or the like.

The AMF may transmit the registration accept message to indicate to the UE that the request from the UE has been rejected or may transmit the registration reject message to indicate to the UE that the request from the UE has been rejected.

Based on whether or not the network supports temporary network slices, or whether or not the network includes capability of processing timing information related to network slices, or whether or not the network includes capability of processing information related to a time or a time period in which network slices are available, the AMF may determine whether or not to include at least one piece of identification information out of the 11th identification information to the 16th identification information in the control message and/or the content of the 11th identification information to the 16th identification information to be transmitted.

Note that the network slices as a target of determination of allowing and disallowing of use of temporary network slices may be only the network slices identified by the S-NSSAI included in the first identification information, or may be the network slices identified by the S-NSSAI included in the first identification information and the S-NSSAI not included in the first identification information.

For example, in a case that the network supports temporary network slices, or the network includes capability of processing timing information related to network slices, or the network includes capability of processing information related to a time or a time period in which network slices are available, the AMF may set the 12th identification information to indicate that the network supports the temporary network slices, or the network includes the capability of processing timing information related to the network slices, or the network includes the capability of processing information related to a time or a time period in which the network slices are available, and transmit the 12th identification information.

In a case that the network does not support temporary network slices, or the network does not include capability of processing timing information related to network slices, or the network does not include capability of processing information related to a time or a time period in which network slices are available, the AMF may set the 12th identification information to indicate that the network does not support the temporary network slices, or the network does not include the capability of processing timing information related to the network slices, or the network does not include the capability of processing information related to a time or a time period in which the network slices are available, and transmit the 12th identification information.

In a case that the network supports temporary network slices, or the network includes capability of processing timing information related to network slices, or the network includes capability of processing information related to a time or a time period in which network slices are available, by transmitting the 11th identification information, and/or the 13th identification information, and/or the 14th identification information, the AMF may notify the UE that the network supports the temporary network slices, or the network includes the capability of processing timing information related to the network slices, or the network includes the capability of processing information related to a time or a time period in which the network slices are available.

In a case that the network does not support temporary network slices, or the network does not include capability of processing timing information related to network slices, or the network does not include capability of processing information related to a time or a time period in which network slices are available, the AMF need not transmit the 13th identification information and/or the 14th identification information.

In a case that the network does not support temporary network slices, or the network does not include capability of processing timing information related to network slices, or the network does not include capability of processing information related to a time or a time period in which network slices are available, by not transmitting the 11th identification information, and/or the 13th identification information, and/or the 14th identification information, the AMF may notify the UE that the network does not support the temporary network slices, or the network does not include the capability of processing timing information related to the network slices, or the network does not include the capability of processing information related to a time or a time period in which the network slices are available.

In a case that the network does not support temporary network slices, or the network does not include capability of processing timing information related to network slices, or the network does not include capability of processing information related to a time or a time period in which network slices are available, the network (for example, the AMF) need not be able to determine allowing and disallowing of use of the temporary network slices.

In a case that the network does not support temporary network slices, or the network does not include capability of processing timing information related to network slices, or the network does not include capability of processing information related to a time or a time period in which network slices are available, the network (for example, the AMF) may discard or ignore the fourth identification information.

In a case that use of temporary network slices is allowed, the AMF may set and store the S-NSSAI for identifying the temporary network slices as the allowed NSSAI and/or the configured NSSAI, and the AMF may set the timer value indicating a time period in which the network slices or the S-NSSAI is available to its own timer and start it. Note that start of the timer may be performed after completion of the present procedure, or may be started during the present procedure. Here, in a case that the S-NSSAI is included in the rejected NSSAI and/or the pending NSSAI, the AMF may remove the S-NSSAI from the rejected NSSAI and/or the pending NSSAI. Furthermore, the AMF may set the S-NSSAI for identifying the network slices to the 11th identification information, set the timer value indicating a time period in which the network slices or the S-NSSAI is available to the 13th identification information, and set information indicating that these pieces of configuration information are enabled to the 14th identification information, and perform transmission to the UE. The AMF may set the S-NSSAI for identifying the network slices to the 11th identification information and perform transmission to the UE, but need not transmit the 13th identification information indicating the timer value indicating a time period in which the network slices or the S-NSSAI is available and/or the 14th identification information indicating that these pieces of configuration information are enabled to the UE.

In a case that use of temporary network slices is allowed, the AMF may set and store the S-NSSAI for identifying the temporary network slices as the allowed NSSAI and/or the configured NSSAI, and the AMF may set the S-NSSAI for identifying the network slices to the 11th identification information, set the timer value indicating a time period in which the network slices or the S-NSSAI is available to the 13th identification information, and set information indicating that these pieces of configuration information are enabled to the 14th identification information, and perform transmission to the UE. In this case, the AMF need not set the timer value indicating a time period in which the network slices or the S-NSSAI is available to its own timer, or need not start the timer. Here, in a case that the S-NSSAI is included in the rejected NSSAI and/or the pending NSSAI, the AMF may remove the S-NSSAI from the rejected NSSAI and/or the pending NSSAI.

In a case that the AMF transmits the 13th identification information and also starts the timer of the AMF, the timer value to be set to the 13th identification information and the timer value to be set to the timer of the AMF may be the same value, or may be different values. In a case that the timer value to be set to the 13th identification information and the timer value to be set to the timer of the AMF are different values, the AMF may perform configuration so that the timer value to be set to the timer of the AMF is larger than the timer value to be set to the 13th identification information.

In a case that use of temporary network slices is not allowed, the AMF may set and store the S-NSSAI for identifying the temporary network slices as the rejected NSSAI, and set the S-NSSAI for identifying the network slices to the 11th identification information and perform transmission to the UE. Here, in a case that the S-NSSAI is included in the allowed NSSAI and/or the configured NSSAI and/or the pending NSSAI, the AMF may remove the S-NSSAI from the allowed NSSAI and/or the configured NSSAI and/or the pending NSSAI.

In a case that use of temporary network slices is not allowed, the AMF may set and store the S-NSSAI for identifying the temporary network slices as the rejected NSSAI, and set the S-NSSAI for identifying the network slices to the 11th identification information and perform transmission to the UE, set a prescribed value (for example, 0) to the 13th identification information as the timer value indicating a time period in which the network slices or the S-NSSAI is available, and set information indicating that these pieces of configuration information are not enabled to the 14th identification information, and perform transmission to the UE. In this case, in a case that the timer corresponding to the network slices or the S-NSSAI is running, the AMF may stop the timer. Here, in a case that the S-NSSAI is included in the allowed NSSAI and/or the configured NSSAI and/or the pending NSSAI, the AMF may remove the S-NSSAI from the allowed NSSAI and/or the configured NSSAI and/or the pending NSSAI.

In a case that use of temporary network slices is not allowed, the AMF may set and store the S-NSSAI for identifying the temporary network slices as the allowed NSSAI and/or the configured NSSAI, set the S-NSSAI for identifying the network slices to the 11th identification information and perform transmission to the UE, set a prescribed value (for example, 0) to the 13th identification information as the timer value indicating a time period in which the network slices or the S-NSSAI is available, and set information indicating that these pieces of configuration information are not enabled to the 14th identification information, and perform transmission to the UE. In this case, in a case that the timer corresponding to the network slices or the S-NSSAI is running, the AMF may stop the timer. Here, in a case that the S-NSSAI is included in the rejected NSSAI and/or the pending NSSAI, the AMF may remove the S-NSSAI from the rejected NSSAI and/or the pending NSSAI.

In a case of receiving the fourth identification information, the AMF may transmit the 11th identification information, and/or the 13th identification information, and/or the 14th identification information. Note that, in a case of having already transmitted the 13th identification information to the UE and receiving the fourth identification information, the AMF may transmit the 13th identification information including the updated timer value. In a case of having already transmitted the 13th identification information to the UE, receiving the fourth identification information, and the timer value being not updated, the AMF need not transmit the 11th identification information, and/or the 13th identification information, and/or the 14th identification information.

The AMF may transmit at least one piece of identification information out of the 11th identification information to the 16th identification information, regardless of whether or not the fourth identification information has been received.

In a case of transmitting at least one piece of identification information out of the 11th identification information to the 16th identification information in the present procedure, by transmitting at least one piece of identification information out of the 11th identification information to the 16th identification information, the AMF may update configuration of the UE by using the control message in the MM procedure different from the present procedure (for example, the configuration update command message in the configuration update procedure). In other words, the content of the identification information transmitted and/or received in the control message in the present procedure and the content of the identification information transmitted and/or received in the control message in the MM procedure different from the present procedure may be different, or may be the same.

For example, configuration information of the UE may be changed by the 11th identification information transmitted and/or received in the control message in the present procedure indicating the NSSAI (for example, the allowed NSSAI and/or the configured NSSAI) including the S-NSSAI for identifying temporary network slices and the 11th identification information transmitted and/or received in the control message in the MM procedure different from the present procedure indicating the NSSAI (for example, the rejected NSSAI) including the S-NSSAI for identifying temporary network slices.

The configuration information of the UE may be changed by the 11th identification information transmitted and/or received in the control message in the present procedure indicating the NSSAI (for example, the rejected NSSAI) including the S-NSSAI for identifying temporary network slices and the 11th identification information transmitted and/or received in the control message in the MM procedure different from the present procedure indicating the NSSAI (for example, the allowed NSSAI and/or the configured NSSAI) including the S-NSSAI for identifying temporary network slices.

The configuration of the UE may be changed by the 13th identification information transmitted and/or received in the control message in the present procedure indicating a value other than O as the timer value indicating a time period in which the network slices or the S-NSSAI is available and the 13th identification information transmitted and/or received in the control message in the MM procedure different from the present procedure indicating 0 as the timer value indicating a time period in which the network slices or the S-NSSAI is available. The configuration of the UE may be changed by the 13th identification information transmitted and/or received in the control message in the present procedure indicating 0 as the timer value indicating a time period in which the network slices or the S-NSSAI is available and the 13th identification information transmitted and/or received in the control message in the MM procedure different from the present procedure indicating a value other than 0 as the timer value indicating a time period in which the network slices or the S-NSSAI is available.

The configuration of the UE may be changed by the 14th identification information transmitted and/or received in the control message in the present procedure indicating that the configuration information is enabled and the 14th identification information transmitted and/or received in the control message in the MM procedure different from the present procedure indicating that the configuration information is not enabled. The configuration of the UE may be changed by the 14th identification information transmitted and/or received in the control message in the present procedure indicating that the configuration information is not enabled and the 14th identification information transmitted and/or received in the control message in the MM procedure different from the present procedure indicating that the configuration information is enabled.

In a case that the timer started during the present procedure or after completion of the present procedure expires, and the S-NSSAI associated with the timer is stored in the allowed NSSAI and/or the configured NSSAI and/or the pending NSSAI, the AMF may remove the S-NSSAI from the stored allowed NSSAI and/or configured NSSAI and/or pending NSSAI.

In a case that the timer started during the present procedure or after completion of the present procedure expires, and the S-NSSAI associated with the timer is not stored in the rejected NSSAI, the AMF may store the S-NSSAI in the rejected NSSAI.

In a case that the timer started during the present procedure or after completion of the present procedure expires, and the S-NSSAI associated with the timer is stored in the allowed NSSAI and/or the configured NSSAI, the AMF may continuously store the S-NSSAI together with information indicating that the S-NSSAI is not enabled or disabled without deleting the S-NSSAI from the stored allowed NSSAI and/or configured NSSAI.

After the timer started during the present procedure or after completion of the present procedure expires, the AMF may initiate the SM procedure (for example, the PDU session release procedure) and/or the MM procedure (for example, the de-registration procedure).

For example, after the timer expires and in a case of initiating the PDU session release procedure, the AMF may notify the SMF of information indicating that there are no network slices associated with the expired timer, and/or S-NSSAI for identifying the network slices, and/or available network slices, or network slices are not available, or network slices are not enabled or disabled, or network slices have timed out, or network slices have expired. The SMF that has received these pieces of information may transmit the PDU session release command including a PDU session ID for identifying a PDU session using the network slices or the S-NSSAI associated with the expired timer, and/or a cause value (5GSM cause), and/or the 11th identification information to the UE via the AMF using the network slices or the S-NSSAI. Here, the cause value (5GSM cause) may indicate that there are no available network slices, or the network slices are not available, or the network slices are not enabled, or the network slices are disabled, or the network slices have timed out, or the network slices have expired. The cause value (5GSM cause) may indicate operator determined barring, insufficient resources, user authentication or authorization failed, regular de-registration (regular deactivation), network failure, reactivation requested, out of LADN service area, insufficient resources for specific slice and DNN, and insufficient resources for specific slice. The 11th identification information may indicate the allowed NSSAI and/or the configured NSSAI and/or the rejected NSSAI.

After the timer expires and in a case of initiating the PDU session release procedure, the AMF may notify the SMF of information indicating that there are no network slices associated with the expired timer, and/or S-NSSAI for identifying the network slices, and/or available network slices, or network slices are not available, or network slices are not enabled or disabled, or network slices have timed out, or network slices have expired. The SMF that has received these pieces of information may implicitly release one or more (or all of) PDU sessions and/or resources using the network slices or the S-NSSAI associated with the expired timer.

After the timer expires and in a case of initiating the de-registration procedure, the AMF may transmit the de-registration request message including at least one piece of identification information out of the 11th identification information and the 13th identification information to the 16th identification information to the UE. For example, in a case of transmitting the 13th identification information, the AMF may indicate a prescribed value (for example, 0). In a case of transmitting the 14th identification information, the AMF may indicate that the configuration information is not enabled or disabled as the 14th identification information. In a case of transmitting the 11th identification information, the AMF may include the network slices or the S-NSSAI associated with the expired timer in the rejected NSSAI. The AMF may include information indicating a request for re-registration in the de-registration request message, and perform transmission to the UE. By transmitting the de-registration request message to the UE, the AMF may request the UE to transmit requested NSSAI including the S-NSSAI indicating other network slices.

After the timer expires, the AMF may implicitly de-register the UE without initiating the de-registration procedure.

In a case of transmitting the 11th identification information, and/or the 13th identification information, and/or the 14th identification information to the UE in the present procedure, after starting its own timer, and in a case that the timer expires, the AMF may monitor whether or not the PDU session release procedure and/or the de-registration procedure is performed by the UE for a prescribed time, and in a case that the PDU session release procedure and/or the de-registration procedure is not initiated by the UE for the prescribed time, the AMF may initiate the SM procedure (for example, the PDU session release procedure) and/or the MM procedure (for example, the de-registration procedure) described above.

In a case of transmitting the 11th identification information, and/or the 13th identification information, and/or the 14th identification information to the UE in the present procedure, after starting its own timer, and in a case that the timer expires, the AMF may monitor whether or not the PDU session release procedure and/or the de-registration procedure is performed by the UE for a prescribed time, and in a case that the PDU session release procedure and/or the de-registration procedure is initiated by the UE for the prescribed time, the AMF need not initiate the SM procedure (for example, the PDU session release procedure) and/or the MM procedure (for example, the de-registration procedure) described above.

In a case of transmitting the 11th identification information, and/or the 13th identification information, and/or the 14th identification information to the UE in the present procedure, after starting its own timer, and in a case that the timer expires, the AMF may immediately initiate the SM procedure (for example, the PDU session release procedure) and/or the MM procedure (for example, the de-registration procedure) described above without monitoring whether or not the PDU session release procedure and/or the de-registration procedure is performed by the UE.

In a case that the third identification information indicates SNPN onborading registration (performs onboarding registration), the 13th identification information and/or the 14th identification information need not be transmitted.

In a case that network slices as a target of temporary network slices are already in an unavailable state, and the AMF receives the registration request message including the requested NSSAI including the S-NSSAI for identifying the network slices from the UE, the AMF may include the 11th identification information and/or the 15th identification information in the control message and transmit the control message to the UE. Here, the 11th identification information may include the S-NSSAI. In this case, in a case that the network slices are to become available in the future, the AMF may include information of the date and time indicating when the network slices become available and/or information indicating a time period before the network slices become available in the control message for transmission.

The network slices as a target of temporary network slices need not be a target of NSAC (MM-based slice admission control and/or SM-based slice admission control).

In a case that the network slices as a target of temporary network slices are network slices as a target of NSAC, the AMF may transmit the S-NSSAI for identifying the network slices to the NSACF. In other words, in a case that the AMF receives the requested NSSAI including the S-NSSAI for identifying network slices as a target of temporary network slices and a target of NSAC, the AMF may transmit the S-NSSAI to the NSACF.

In a case that the AMF receives the MM message (for example, the registration request message or the de-registration request message) including the requested NSSAI including the S-NSSAI for identifying network slices as a target of temporary network slices and a target of NSAC and the timer in the AMF for the S-NSSAI or the network slices identified by the S-NSSAI expires, the AMF may transmit the S-NSSAI, and/or the S-NSSAI or the network slices identified by the S-NSSAI having become unavailable, and/or the timer for the S-NSSAI or the network slices identified by the S-NSSAI having expired, and/or the S-NSSAI or the network slices identified by the S-NSSAI having become unavailable due to expiration of the timer for the S-NSSAI or the network slices identified by the S-NSSAI to the NSACF. The NSACF that has received these pieces of control information may cancel NSAC (MM-based slice admission control) for the S-NSSAI or the network slices identified by the S-NSSAI. The NSACF may transmit the S-NSSAI and/or cancellation of NSAC for the S-NSSAI or the network slices identified by the S-NSSAI to the AMF. The AMF that has received these pieces of control information may transmit the MM message (for example, the registration accept message or the registration reject message or the de-registration accept message) including the S-NSSAI and/or cancellation of NSAC for the S-NSSAI or the network slices identified by the S-NSSAI to the UE. The UE that has received these pieces of control information may be able to recognize the received content.

In a case that the AMF receives the MM message (for example, the registration request message or the de-registration request message) including the requested NSSAI including the S-NSSAI for identifying network slices as a target of temporary network slices and a target of NSAC and the timer in the AMF for the S-NSSAI or the network slices identified by the S-NSSAI expires, without performing the transmission to the NSACF, by transmitting the control message including the 11th identification information and/or the 15th identification information, the AMF may transmit, to the UE, the MM message (for example, the registration accept message or the registration reject message or the de-registration accept message) including the S-NSSAI, and/or the S-NSSAI or the network slices identified by the S-NSSAI having become unavailable, and/or the timer for the S-NSSAI or the network slices identified by the S-NSSAI having expired, and/or the S-NSSAI or the network slices identified by the S-NSSAI having become unavailable due to expiration of the timer for the S-NSSAI or the network slices identified by the S-NSSAI. The UE that has received these pieces of control information may be able to recognize the received content.

In a case that the AMF receives the MM message (for example, the registration request message or the de-registration request message) including the requested NSSAI including the S-NSSAI for identifying network slices as a target of temporary network slices and a target of NSAC, and the timer in the AMF for the S-NSSAI and/or the network slices identified by the S-NSSAI expires, the AMF may perform the transmission to the NSACF and perform the transmission to the UE. Subsequent behaviors of the NSACF, the AMF, and the UE may be the same as those described above.

In a case that the AMF receives the S-NSSAI for identifying network slices as a target of temporary network slices and a target of NSAC and the SM message (for example, the PDU session establishment request message or the PDU session release request message), and the timer in the AMF for the S-NSSAI or the network slices identified by the S-NSSAI expires, the AMF may transmit the S-NSSAI, and/or the S-NSSAI or the network slices identified by the S-NSSAI having become unavailable, and/or the timer for the S-NSSAI or the network slices identified by the S-NSSAI having expired, and/or the S-NSSAI and/or the network slices identified by the S-NSSAI having become unavailable due to expiration of the timer for the S-NSSAI or the network slices identified by the S-NSSAI to the NSACF and/or the SMF. The AMF may transmit the received SM message to the SMF. In a case that the SMF receives these pieces of control information, the SMF may transmit the S-NSSAI, and/or the S-NSSAI or the network slices identified by the S-NSSAI having become unavailable, and/or the timer for the S-NSSAI or the network slices identified by the S-NSSAI having expired, and/or the S-NSSAI or the network slices identified by the S-NSSAI having become unavailable due to expiration of the timer for the S-NSSAI or the network slices identified by the S-NSSAI to the NSACF. The NSACF that has received these pieces of control information from the AMF and/or the SMF may cancel NSAC (SM-based slice admission control) for the S-NSSAI or the network slices identified by the S-NSSAI. The NSACF may transmit the S-NSSAI and/or cancellation of NSAC for the S-NSSAI or the network slices identified by the S-NSSAI to the SMF and/or the AMF. In a case that the SMF receives these pieces of control information, the SMF may transmit the S-NSSAI and/or cancellation of NSAC for the S-NSSAI or the network slices identified by the S-NSSAI to the AMF. The AMF that has received these pieces of control information may be able to recognize the received content. Furthermore, the SMF may transmit the S-NSSAI, and/or the SM message (for example, the PDU session establishment accept message or the PDU session establishment reject message or the PDU session release command message) including the 11th identification information and/or the 15th identification information to the UE via the AMF. The UE that has received these pieces of control information may be able to recognize the received content.

In a case that the AMF receives the S-NSSAI for identifying network slices as a target of temporary network slices and a target of NSAC and the SM message (for example, the PDU session establishment request message or the PDU session release request message), and the timer in the AMF for the S-NSSAI or the network slices identified by the S-NSSAI expires, without performing the transmission described above to the NSACF and/or the SMF, the AMF may transmit the S-NSSAI, and/or the S-NSSAI or the network slices identified by the S-NSSAI having become unavailable, and/or the timer for the S-NSSAI or the network slices identified by the S-NSSAI having expired, and/or the S-NSSAI or the network slices identified by the S-NSSAI having become unavailable due to expiration of the timer for the S-NSSAI or the network slices identified by the S-NSSAI, and/or the control message including the 11th identification information and/or the 15th identification information to the UE. The control message transmitted from the AMF to the UE in this case may be an MM message other than the registration accept message or the registration reject message. The UE that has received these pieces of control information may be able to recognize the received content.

In a case that the AMF receives the S-NSSAI for identifying network slices as a target of temporary network slices and a target of NSAC and the SM message (for example, the PDU session establishment request message or the PDU session release request message), and the timer in the AMF for the S-NSSAI or the network slices identified by the S-NSSAI expires, the AMF may perform the transmission to the NSACF and/or the SMF and perform the transmission to the UE. Subsequent behaviors of the NSACF, the SMF, the AMF, and the UE may be the same as those described above.

Next, the UE receives the control message and/or the transmitted identification information (at least one piece of identification information out of the 11th identification information to the 16th identification information) via the base station apparatus (S610). In a case that the control message is the registration accept message, by receiving the registration accept message, the UE may recognize that the request of the UE on the registration request message has been accepted and/or the content of various pieces of identification information included in the registration accept message. In a case that the control message is the registration reject message, by receiving the registration reject message, the UE may recognize that the request of the UE on the registration request message has been rejected and/or the content of various pieces of identification information included in the registration reject message.

In a case of receiving at least one piece of identification information out of the 11th identification information to the 16th identification information from the core network, the UE may store information indicated by the received identification information, or may perform a behavior based on the information indicated by the received identification information.

For example, in a case that the 12th identification information indicates that the network supports temporary network slices, or the network includes capability of processing timing information related to network slices, or the network includes capability of processing information related to a time or a time period in which network slices are available, the UE may recognize that the network supports the temporary network slices, or the network includes the capability of processing timing information related to the network slices, or the network includes the capability of processing information related to a time or a time period in which the network slices are available.

In a case that the 12th identification information indicates that the network does not support temporary network slices, or the network does not include capability of processing timing information related to network slices, or the network does not include capability of processing information related to a time or a time period in which network slices are available, the UE may recognize the 12th identification information and that the network does not support the temporary network slices, or the network does not include the capability of processing timing information related to the network slices, or the network does not include the capability of processing information related to a time or a time period in which the network slices are available.

By receiving the 11th identification information, and/or the 13th identification information, and/or the 14th identification information, the UE may recognize that the network supports the temporary network slices, or the network includes the capability of processing timing information related to the network slices, or the network includes the capability of processing information related to a time or a time period in which the network slices are available.

By not receiving the 11th identification information, and/or the 13th identification information, and/or the 14th identification information, the UE may recognize that the network does not support the temporary network slices, or the network does not include the capability of processing timing information related to the network slices, or the network does not include the capability of processing information related to a time or a time period in which the network slices are available.

In a case of transmitting the second identification information indicating that the UE does not support temporary network slices, or the UE does not include capability of processing timing information related to network slices, or the UE does not include capability of processing information related to a time or a time period in which network slices are available, the UE may discard or ignore the 13th identification information and/or the 14th identification information.

In a case of not transmitting the second identification information related to whether or not the UE supports temporary network slices, or whether or not the UE includes capability of processing timing information related to network slices, or whether or not the UE includes capability of processing information related to a time or a time period in which network slices are available, the UE may discard or ignore the 13th identification information and/or the 14th identification information.

In a case that the UE receives the 11th identification information indicating the NSSAI (for example, the allowed NSSAI and/or the configured NSSAI) including the S-NSSAI for identifying temporary network slices, and/or the 13th identification information indicating the timer value indicating a time period in which the network slices or the S-NSSAI is available, and/or the 14th identification information indicating that these pieces of configuration information are enabled, the UE may store the S-NSSAI as the allowed NSSAI and/or the configured NSSAI, and set the timer value indicated by the 13th identification information to its own timer and start it. Note that start of the timer may be performed after completion of the present procedure, or may be started during the present procedure. Here, in a case that the S-NSSAI is included in the rejected NSSAI and/or the pending NSSAI, the UE may remove the S-NSSAI from the rejected NSSAI and/or the pending NSSAI.

In a case that the UE receives the 11th identification information indicating the NSSAI (for example, the allowed NSSAI and/or the configured NSSAI) including the S-NSSAI for identifying temporary network slices, and does not receive the 13th identification information indicating the timer value indicating a time period in which the network slices or the S-NSSAI is available and/or the 14th identification information indicating that these pieces of configuration information are enabled, the UE may store the S-NSSAI as the allowed NSSAI and/or the configured NSSAI, but need not set the timer value indicated by the 13th identification information to its own timer or need not start it. Here, in a case that the S-NSSAI is included in the rejected NSSAI and/or the pending NSSAI, the UE may remove the S-NSSAI from the rejected NSSAI and/or the pending NSSAI.

In a case that the UE receives the 11th identification information indicating the NSSAI (for example, the rejected NSSAI) including the S-NSSAI for identifying temporary network slices, the UE may store the S-NSSAI as the rejected NSSAI. Here, in a case that the S-NSSAI is included in the allowed NSSAI and/or the configured NSSAI and/or the pending NSSAI, the UE may remove the S-NSSAI from the allowed NSSAI and/or the configured NSSAI and/or the pending NSSAI.

In a case that the UE receives the 11th identification information indicating the NSSAI (for example, the rejected NSSAI) including the S-NSSAI for identifying temporary network slices, and/or the 13th identification information indicating a prescribed value (for example, 0) as the timer value indicating a time period in which the network slices or the S-NSSAI is available, and/or the 14th identification information indicating these pieces of configuration information is not enabled, the UE may store the S-NSSAI as the rejected NSSAI, and stop the timer in a case that the timer corresponding to the network slices or the S-NSSAI is running. Here, in a case that the S-NSSAI is included in the allowed NSSAI and/or the configured NSSAI and/or the pending NSSAI, the AMF may remove the S-NSSAI from the allowed NSSAI and/or the configured NSSAI and/or the pending NSSAI.

In a case that the UE receives the 11th identification information indicating the NSSAI (for example, the allowed NSSAI and/or the configured NSSAI) including the S-NSSAI for identifying temporary network slices, and/or the 13th identification information indicating a prescribed value (for example, 0) as the timer value indicating a time period in which the network slices or the S-NSSAI is available, and/or the 14th identification information indicating these pieces of configuration information is not enabled, the UE may stop the timer in a case that the timer corresponding to the network slices or the S-NSSAI is running. Here, in a case that the S-NSSAI is included in the rejected NSSAI and/or the pending NSSAI, the UE may remove the S-NSSAI from the rejected NSSAI and/or the pending NSSAI.

In a case of transmitting the fourth identification information and receiving the 11th identification information, and/or the 13th identification information, and/or the 14th identification information, the UE may update already stored information to the content of the received identification information. For example, after starting the timer using the timer value indicated by already received 13th identification information and in a case of receiving new 13th identification information in the present procedure, the UE may reset the timer value indicated by the new 13th identification information to its own timer. After starting the timer using the timer value indicated by already received 13th identification information and in a case of not receiving the 11th identification information, and/or the 13th identification information, and/or the 14th identification information in the present procedure, it may be recognized that the configuration is not updated. After starting the timer using the timer value indicated by already received 13th identification information and in a case of transmitting the fourth identification information and not receiving the 11th identification information, and/or the 13th identification information, and/or the 14th identification information in the present procedure, it may be recognized that the configuration is not updated.

In a case of receiving at least one piece of identification information out of the 11th identification information to the 16th identification information in the present procedure, and receiving at least one piece of identification information out of the 11th identification information to the 16th identification information by using the control message in the MM procedure different from the present procedure (for example, the configuration update command message in the configuration update procedure), the UE may update the configuration of the UE to the content of the received identification information.

In a case that the timer started during the present procedure or after completion of the present procedure expires, and the S-NSSAI associated with the timer is stored in the allowed NSSAI and/or the configured NSSAI and/or the pending NSSAI, the UE may remove the S-NSSAI from the stored allowed NSSAI and/or configured NSSAI and/or pending NSSAI.

In a case that the timer started during the present procedure or after completion of the present procedure expires, and the S-NSSAI associated with the timer is not stored in the rejected NSSAI, the UE may store the S-NSSAI in the rejected NSSAI.

In a case that the timer started during the present procedure or after completion of the present procedure expires, and the S-NSSAI associated with the timer is stored in the allowed NSSAI and/or the configured NSSAI, the UE may continuously store the S-NSSAI together with information indicating that the S-NSSAI is not enabled or disabled without deleting the S-NSSAI from the stored allowed NSSAI and/or configured NSSAI.

After the timer started during the present procedure or after completion of the present procedure expires, the UE may initiate the SM procedure (for example, the PDU session release procedure) and/or the MM procedure (for example, the de-registration procedure).

For example, after the timer expires, in a case of initiating the PDU session release procedure, the UE may transmit the PDU session release request message including the network slices associated with the expired timer and/or the S-NSSAI for identifying the network slices, and/or a PDU session ID for identifying a PDU session using the network slices or the S-NSSAI, and/or a cause value (5GSM cause) to the SMF via the AMF using the network slices or the S-NSSAI. Here, the cause value (5GSM cause) may indicate that there are no available network slices, or the network slices are not available, or the network slices are not enabled, or the network slices are disabled, or the network slices have timed out, or the network slices have expired. The cause value (5GSM cause) may indicate insufficient resources, regular de-registration (regular deactivation), Semantic errors in packet filter(s), Syntactical error in packet filter(s), Semantic error in the QoS operation, Syntactical error in the QoS operation, and Invalid mandatory information.

After the timer expires and in a case of initiating the PDU session release procedure, the UE may implicitly release one or more (or all of) PDU sessions and/or resources using the network slices or the S-NSSAI associated with the expired timer.

After the timer expires and in a case of initiating the de-registration procedure, the UE may transmit the de-registration request message including at least one piece of identification information out of the 11th identification information and the 13th identification information to the 16th identification information, and/or information indicating that there are no available network slices, or the network slices are not available, or the network slices are not enabled, or the network slices are disabled, or the network slices have timed out, or the network slices have expired to the network.

After the timer expires, the UE may implicitly perform de-registration without initiating the de-registration procedure.

After the timer is started and in a case that the timer expires, the UE may monitor whether or not the PDU session release procedure and/or the de-registration procedure is performed by the network for a prescribed time, and in a case that the PDU session release procedure and/or the de-registration procedure is not initiated by the network for the prescribed time, the UE may initiate the SM procedure (for example, the PDU session release procedure) and/or the MM procedure (for example, the de-registration procedure) described above.

After the timer is started and in a case that the timer expires, the UE may immediately initiate the SM procedure (for example, the PDU session release procedure) and/or the MM procedure (for example, the de-registration procedure) described above without monitoring whether or not the PDU session release procedure and/or the de-registration procedure is performed by the network.

After starting the timer using the timer value indicated by the 13th identification information and in a case of receiving the 13th identification information in the MM message in another MM procedure before the timer expires, the UE may reset the timer value indicated by the 13th identification information to the timer and start it. After starting the timer using the timer value indicated by the 13th identification information and in a case of receiving the 13th identification information in another MM procedure before the timer expires, the UE may stop the running timer, and set the timer value indicated by the 13th identification information to the timer and start it.

After starting the timer using the timer value indicated by the 13th identification information and in a case of receiving the 13th identification information indicating a prescribed value (for example, 0) in the MM message in another MM procedure before the timer expires, the UE may recognize that the S-NSSAI included in the 11th identification information corresponding to the 13th identification information or network slices identified by the S-NSSAI are unavailable.

In a case of receiving the 13th identification information and before the timer expires, the UE may recognize that the S-NSSAI included in the 11th identification information corresponding to the 13th identification information or network slices identified by the S-NSSI are available. In a case of receiving the 13th identification information and after the timer expires, the UE may recognize that the S-NSSAI included in the 11th identification information corresponding to the 13th identification information or network slices identified by the S-NSSAI are unavailable.

In a case that the UE does not support temporary network slices, or the UE does not include capability of processing timing information related to network slices, or the UE does not include capability of processing information related to a time or a time period in which network slices are available, and the UE receives the 13th identification information in the present procedure or in the MM message in another MM procedure, the UE need not be able to discard, ignore, or recognize the 13th identification information.

By receiving the 11th identification information, and/or the 13th identification information, and/or the 14th identification information, the UE may recognize that the network supports the temporary network slices, or the network includes the capability of processing timing information related to the network slices, or the network includes the capability of processing information related to a time or a time period in which the network slices are available.

In a case of receiving the 11th identification information, and/or the 13th identification information, and/or the 14th identification information and before the timer value indicated by the 13th identification information expires, the UE may store the S-NSSAI included in the NSSAI (for example, the configured NSSAI and/or the allowed NSSAI) indicated by the 11th identification information in the configured NSSAI and/or the allowed NSSAI. In this case, the UE may store the S-NSSAI and the timer value indicated by the 13th identification information or the timer set with the timer value in association with each other. In other words, before the timer value indicated by the 13th identification information or the timer set with the timer value expires, the UE may recognize that configuration of the S-NSSAI stored in the configured NSSAI and/or the allowed NSSAI is enabled. In still other words, after the timer value indicated by the 13th identification information or the timer set with the timer value expires, the UE may recognize that configuration of the S-NSSAI stored in the configured NSSAI and/or the allowed NSSAI is disabled. After the timer value indicated by the 13th identification information or the timer set with the timer value expires, the UE may remove the S-NSSAI stored in the configured NSSAI and/or the allowed NSSAI, and store the S-NSSAI as the rejected NSSAI.

In a case that network slices as a target of temporary network slices are already in an unavailable state, the UE may transmit the registration request message including the requested NSSAI including the S-NSSAI for identifying the network slices to the AMF, and receive the control message including the 11th identification information and/or the 15th identification information from the AMF, and in a case that the S-NSSAI is included in the 11th identification information, the UE may recognize that the network slices identified by the S-NSSAI are unavailable. Furthermore, in a case that information of the date and time indicating when the network slices become available and/or information indicating a time period before the network slices become available is included in the control message, the UE may be able to recognize that the network slices are to become available in the future, and/or when the network slices become available, and/or a time period before the network slices become available.

In a case that the control message is the registration accept message, the UE may transmit the registration complete message to the AMF via the base station apparatus, as a response message to the registration accept message (S612). Here, although the registration complete message is a NAS message transmitted and/or received over the N1 interface, the registration complete message may be included in the RRC message in a case of being transmitted and/or received between the UE and the base station apparatus.

Next, the AMF receives the registration complete message via the base station apparatus (S612).

In addition, each apparatus completes the present procedure based on transmission and/or reception of the registration accept message and/or the registration complete message. Based on transmission and/or reception of the registration accept message and/or the registration complete message, each apparatus may recognize that the present procedure has completed normally.

Each apparatus may complete the registration procedure based on the transmission and/or reception of the registration reject message. Based on transmission and/or reception of the registration reject message, each apparatus may recognize that the present procedure has not completed normally, or may recognize that the present procedure has completed abnormally.

Note that, based on transmission and/or reception of the registration accept message and/or the registration complete message, each apparatus may transition to or maintain the state (the RM_REGISTERED state or the 5GMM-REGISTERED state) in which the UE is registered with the network. Based on transmission and/or reception of the registration reject message, each apparatus may transition to or maintain the state (the RM_DEREGISTERED state or the 5GMM-DEREGISTERED state) in which the UE is not registered with the network on the access in which the registration reject message is received for the current PLMN. Also, the transition of each apparatus to each state may be performed based on transmission and/or reception of the registration complete message, or completion of the registration procedure.

Furthermore, each apparatus may perform processing based on information transmitted and/or received in the registration procedure, based on completion of the registration procedure. For example, in a case that information indicating that a part of the request from the UE has been rejected is transmitted and/or received, the cause for rejection of the request from the UE may be recognized. Furthermore, each apparatus may perform the present procedure again or may perform the registration procedure on the core network_A or another cell based on the reason for the rejection of the request from the UE.

Moreover, the UE may store the identification information received along with the registration accept message and/or the registration reject message or may recognize determination of the network based on the completion of the registration procedure.

Each apparatus may store the pieces of information transmitted and/or received in the present procedure in association with one another.

### 5. Modifications

A program running on an apparatus according to the present invention may serve as a program that controls a Central Processing Unit (CPU) and the like to cause a computer to function to realize the functions of the aforementioned embodiments according to the present invention. Programs or information handled by the programs are temporarily stored in a volatile memory such as a Random Access Memory (RAM), a non-volatile memory such as a flash memory, a Hard Disk Drive (HDD), or another storage apparatus system.

Note that a program for realizing the functions of the embodiments according to the present invention may be recorded on a computer-readable recording medium. It may be implemented by causing a computer system to read and perform the program recorded on this recording medium. It is assumed that the “computer system” refers to a computer system built into the apparatuses, and the computer system includes an operating system and hardware components such as a peripheral device. In addition, the “computer-readable recording medium” may be a semiconductor recording medium, an optical recording medium, a magnetic recording medium, a medium dynamically retaining the program for a short time, or any other computer-readable recording medium.

In addition, each functional block or various features of the apparatuses used in the aforementioned embodiments may be implemented or performed on an electric circuit, for example, an integrated circuit or multiple integrated circuits. An electric circuit designed to perform the functions described in the present specification may include a general-purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or may be a processor of a known type, a controller, a micro-controller, or a state machine instead. The aforementioned electric circuit may include a digital circuit or may include an analog circuit. Furthermore, in a case that with advances in semiconductor technology, a circuit integration technology appears that replaces the present integrated circuits, it is also possible to use a new integrated circuit based on the technology according to one or more aspects of the present invention.

Note that the invention of the present application is not limited to the above-described embodiments. Although apparatuses have been described as an example in the embodiments, the invention of the present application is not limited to these apparatuses, and is applicable to a terminal apparatus or a communication apparatus of a fixed-type or a non-stationary electronic apparatus installed indoors or outdoors, for example, an AV apparatus, a kitchen apparatus, a cleaning or washing machine, an air-conditioning apparatus, office equipment, a vending machine, and other household apparatuses.

Although the embodiments of the present invention have been described in detail above referring to the drawings, the specific configuration is not limited to the embodiments and includes, for example, design changes within the scope that do not depart from the gist of the present invention. Furthermore, in the present invention, various modifications are possible within the scope of claims, and embodiments that are made by suitably combining technical means disclosed according to the different embodiments are also included in the technical scope of the present invention. In addition, a configuration in which elements described in the respective embodiments and having mutually similar effects are substituted for one another is also included.

### REFERENCE SIGNS LIST

1 Mobile communication system
10 UE_A
30 PGW-U
32 PGW-C
40 MME
45 eNB
50 HSS
60 PCRF
80 Access network_A (E-UTRAN)
90 Core network_A
120 Access network_B (5G AN)
122 gNB
130 UPF
132 SMF
140 AMF
150 UDM
160 PCF
190 Core network_B

1. (canceled)

2. A User Equipment (UE) comprising:
transmission and reception circuitry;
a controller; and
storage circuitry, wherein
the storage circuitry is storing:
a first Single Network Slice Selection Assistance Information (S-NSSAI); and
first control information related to a time period when a network slice identified by the first S-NSSAI is available,
wherein the first S-NSSAI is an S-NSSAI included in a configured Network Slice Selection Assistance Information (NSSAI) stored in the storage circuitry, and
in a case that the transmission and reception circuitry received a configuration update command message, the configuration update command message including the first S-NSSAI and second control information related to a time period when a network slice identified by the first S-NSSAI is available, the controller is configured to:
update the first control information stored in the storage circuitry to the second control information, and
remove the first S-NSSAI from the configured NSSAI stored in the storage circuitry, based on the second control information.

3. A User Equipment (UE) comprising:
transmission and reception circuitry;
a controller; and
storage circuitry, wherein
the storage circuitry is storing:
a first Single Network Slice Selection Assistance Information (S-NSSAI), and
first control information related to a time period when a network slice identified by the first S-NSSAI is available,
in a case that the transmission and reception circuitry received a configuration update command message, the configuration update command message including a configured Network Slice Selection Assistance Information (NSSAI), the configured NSSAI including the first S-NSSAI and second control information related to a time period when a network slice identified by the first S-NSSAI is available, the controller is configured to:
store the configured NSSAI in the storage circuitry;
update the first control information stored in the storage circuitry to the second control information; and
remove the first S-NSSAI from the configured NSSAI stored in the storage circuitry, based on the second control information.

4. A communication control method performed by a User Equipment (UE), the communication control method comprising:
storing:
a first Single Network Slice Selection Assistance Information (S-NSSAI); and
first control information related to a time period when a network slice identified by
wherein the first S-NSSAI is an S-NSSAI included in a configured Network Slice Selection Assistance Information (NSSAI) stored in the storage circuitry, and
in a case that the transmission and reception circuitry received a configuration update command message, the configuration update command message including the first S-NSSAI and second control information related to a time period when a network slice identified by the first S-NSSAI is available,
updating the first control information stored in the storage circuitry to the second control information, and
removing the first S-NSSAI from the configured NSSAI stored in the storage circuitry, based on the second control information.
